(19) United States
(12) Patent Application Publication
(10) Pub. No.: US 2014/0343891 A1
(43) Pub. Date: Nov. 20, 2014

(54) DISTRIBUTED REMOTE SENSING SYSTEM SENSING DEVICE

(71) Applicant: fybr, Chesterfield, MO (US)

(72) Inventors: Paul Becker, Eureka, MO (US); Richard E. Goodwin, St. Louis, MO (US); Edwin Horton, Wildwood, MO (US); Gregory L. Charvat, Westbrook, CT (US)

(73) Assignee: fybr, Chesterfield, MO (US)

(21) Appl. No.: 14/281,015

(22) Filed: May 19, 2014

Related U.S. Application Data
(60) Provisional application No. 61/824,512, filed on May 17, 2013.

(51) Int. Cl. G07F 17/24

(52) U.S. Cl. CPC G07F 17/246
USPC 702/150; 342/27

(57) ABSTRACT

A vehicle detection sensor apparatus including a frame and a dual mode sensor connected to the frame, the dual mode sensor having an active and a passive sensing mode wherein at least one of the active and passive sensing mode is automatically cycled between on and off states when providing a positive reading condition.

### CROSS-REFERENCE TO RELATED APPLICATIONS

This application is a non-provisional of and claims the benefit of U.S. provisional patent application No. 61/824,512 filed on May 17, 2013, the disclosure of which is incorporated by reference herein in its entirety.

### BACKGROUND

1. Field

The exemplary embodiments generally relate to distributed remote sensing systems and, more particularly, to distributed remote sensing systems having remote sensors for sensing a predetermined physical characteristic.

2. Brief Description of Related Developments

Parking monitoring/detection systems have traditionally been used to raise revenue. Such devices have included a timer and a winding mechanism requiring coins. More recently, electronic meters have been developed which include an electronic timer having an LCD time indicator.

With the advent of electronic parking monitoring devices, attempts have been made to make the parking monitors interactive with vehicle traffic in the associated parking space. One way to obtain information about vehicle traffic at parking spaces is to couple the parking monitor to a vehicle sensing device. The vehicle sensing device can detect when a vehicle enters a parking space as well as when the vehicle leaves. Attempts have also been made to centralized vehicle parking space monitoring where data collected by the vehicle sensing devices is ultimately transferred to a centralized monitoring location for analysis and application to user accounts.

Generally, the vehicle sensing devices and communication means between the vehicle sensing devices and the centralized monitoring location must be powered. It may be prohibitive to provide hard lined power to each vehicle sensing device and each communication means. As such, the vehicle sensing devices and communications means may have limited power supplies. The parking monitoring system components are also subject to failure and/or outages.

It would be advantageous to have a distributed remote sensing system that improves reliability through one or more redundancies in the system as well as improve power management of the system components.

### BRIEF DESCRIPTION OF THE DRAWINGS

The foregoing aspects and other features of the disclosed embodiment are explained in the following description, taken in connection with the accompanying drawings, wherein:

FIG. 1 is a schematic illustration of a portion of a vehicle metering system in accordance with aspects of the disclosed embodiment;

FIG. 2 is a schematic illustration of a portion of the vehicle metering system of FIG. 1 in accordance with aspects of the disclosed embodiment;

FIG. 2A is a flow diagram in accordance with aspects of the disclosed embodiment;

FIG. 3 is a schematic illustration of a portion of the vehicle metering system of FIG. 1 in accordance with aspects of the disclosed embodiment;

FIG. 4 is a flow diagram in accordance with aspects of the disclosed embodiment;

FIG. 5 is a flow diagram in accordance with aspects of the disclosed embodiment;

FIG. 6 is a flow diagram in accordance with aspects of the disclosed embodiment;

FIG. 7A is a schematic illustration of a portion of a vehicle metering system in accordance with aspects of the disclosed embodiment;

FIG. 7B is a schematic illustration of a portion of a vehicle metering system in accordance with aspects of the disclosed embodiment;

FIG. 7C is a schematic illustration of a portion of a vehicle metering system in accordance with aspects of the disclosed embodiment;

FIG. 8 is a control flow diagram in accordance with aspects of the disclosed embodiment;

FIGS. 9A and 9B are exemplary range-to-target plots in accordance with aspects of the disclosed embodiment;

FIG. 10 is a control flow diagram in accordance with aspects of the disclosed embodiment;

FIG. 10A is a control flow diagram in accordance with aspects of the disclosed embodiment;

FIG. 11 is a control flow diagram in accordance with aspects of the disclosed embodiment;

FIG. 11A is a control flow diagram in accordance with aspects of the disclosed embodiment;

FIG. 12 is an exemplary control output in accordance with aspects of the disclosed embodiment; and

FIG. 13 is a schematic illustration of a portion of a vehicle metering system in accordance with aspects of the disclosed embodiment.

### DETAILED DESCRIPTION

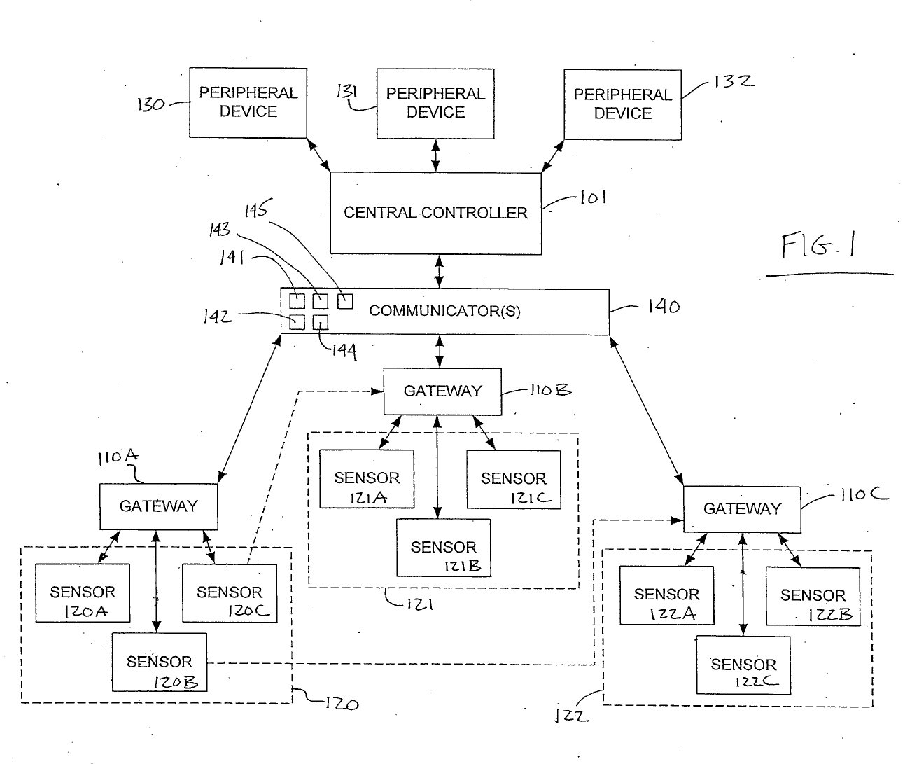

FIG. 1 is a schematic illustration of a portion of a distributed remote sensing system in accordance with aspects of the disclosed embodiment. The distributed remote sensing system may include remote sensors for sensing characteristics such as vehicle detection, traffic patterns, vehicle navigation, vehicle position or any suitable predetermined characteristic. Although the aspects of the disclosed embodiment will be described with reference to the drawings, it should be understood that the aspects of the disclosed embodiment can be embodied in many forms. In addition, any suitable size, shape or type of elements or materials could be used.

In one aspect the distributed remote sensing system may be a vehicle metering/detection system 100, such as for parking metering, traffic metering, navigation or any other suitable vehicle monitoring, having a centralized controller that may provide at least monitoring and/or billing services for the use of one or more vehicle parking spaces. In one aspect, the vehicle metering system 100 may include a central controller 101, one or more gateways 110A-110C, one or more vehicle parking detectors (also referred to as sensing device groups) 120-122 and one or more peripheral devices 130-132 which may include any suitable display for displaying any suitable information pertaining to one or more parking spaces. In other aspects the vehicle metering system may include any suitable number and type of components to facilitate the monitoring of the vehicle parking spaces associated with the vehicle metering system 100. The central controller 101 may be any suitable controller capable of communicating with the one or more gateways 110A-110C (and sensing devices in communication with the one or more gateways) and the one or more peripheral devices 130-132 using any suitable wireless or wired communication interface link that extends from the sensing devices to the central controller and from the central controller to the peripheral devices (it is noted that the interface may include a single communication protocol or a combination of different communication protocols). In one aspect communication between at least the central controller 101 and one or more of the gateways 110A-110C (as well as the sensing devices) and/or peripheral devices 130-132 may be through a cellular communication link 141, a satellite communication link 142, public switched telephone network 145, Internet/World Wide Web 143, Ethernet 144, local area network or other suitable wireless or wired protocol or connection. In one aspect communications from the sensing devices in the sensing device groups 120-122 may be provided substantially in real time to the central controller 101 and/or peripheral devices 130-132.

The central controller 101 may include one or more processors, a memory and any other suitable hardware/software configured to track and report, for each parking space being monitored, a user of the parking space, parking space assignments/allocations, time of arrival, time of departure, transaction rates, user account monetary balances, billing transactions, parking violations, parking space availability or any other suitable information pertaining to the use and billing of each parking space monitored by the vehicle metering system 100. The central controller 101 may be configured with one or more user interfaces to allow user access to and operation of the central controller 101. In one aspect the central controller may be any suitable computing device having a monitor, keyboard and/or other suitable user interface. In other aspects, one or more of the peripheral devices 130-132 may provide a user interface for accessing and operating the central controller 101 either through any suitable long or short range wireless communication link and/or through a wired connection. The central controller 101 may be configured to receive any suitable data from the sensing devices. The data sent from the sensing devices may include or otherwise embody, for example, any suitable data related to a parking space being monitored, vehicle detection, and or a health and welfare/maintenance status of the sensing device. In one aspect the central controller may be configured to perform any suitable processing on the data from the sensing devices while in other aspects the data from the sensing devices may be configured, e.g. without processing by the central controller, for display on one or more of the peripheral devices.

In one aspect one or more of the peripheral devices 130-132 may include, for example, an enforcement unit which may be a hand held unit for use by parking/law enforcement personnel. The enforcement unit may be configured to report parking violations and/or the issuance of parking tickets to the central controller 101 so that electronic ticketing and data capture is integrated into the distributed remote sensing system. For example, a law enforcement officer using a peripheral device 130-132 may arrive at a parking space after being notified of a violation and make a visual inspection of the parking space to verify that there is a vehicle in violation of a law. The violation may be entered into the peripheral device 130-132 and optionally pictures of the vehicle in violation can be taken with the peripheral device or otherwise loaded into the peripheral device. A citation may be generated in any suitable manner, such as being printed from the peripheral device 130-132 and affixed to the vehicle in any suitable manner. The enforcement unit may also report any other actions taken by, for example, the parking enforcement personnel and/or any other suitable information to the central controller 101. As such, violation data entered into the peripheral device is automatically captured and stored in a memory, such as a memory of the central controller 101 in substantially real time. As may be realized storing the violation information within the distributed remote sensing system stops the system from alerting an enforcement office to that space until another violation threshold is met or a new vehicle parks in the space. In another aspect, the sensing devices may also be used in non-parking spaces such as in front of fire hydrants, fire lanes, cross walks, intersections, lanes of a navigable roadway, etc. The distributed remote sensing system can be configured to create a violation after any suitable predetermined time period whenever a vehicle is parked in one of these non-parking spaces so that an alert is sent to an enforcement officer through, for example, a peripheral device 130-132. As may be realized, the distributed remote sensing system may incorporate any other suitable sensors such as cameras and infrared sensors that may be used in conjunction with the sensing devices of the sensor groups 120-122. Information from the cameras and/or infrared sensors may be used in conjunction with the violation data provided by the sensing devices of the sensor groups 120-122 to track violations and the history of the violations. The violation history can be printed from, e.g., a peripheral device 130-132 for adjudication purposes, including parking sensor time stamps of vehicle entry/exit from a parking space.

The one or more of the peripheral devices 130-132 may also include, for example, a motorist unit which may be a handheld unit for use by motorists accessing the parking spaces that are monitored by the vehicle metering system 100. In one aspect the motorist unit may be a dedicated vehicle parking system hand held unit while in other aspects the motorist unit may be integrated into a user's wireless phone, vehicle GPS unit, or other user computing device such as through an application program capable of running on the wireless phone, GPS unit or other computing device. In still other aspects the motorist unit may be implemented in any suitable manner for allowing the motorist to, for example, check an account balance, add funds to the user's account, perform billing/violation payment transactions, find available parking spaces or any other suitable action(s) such as reserving one or more parking spaces for a predetermined time and date. The motorist unit may provide a motorist with way finding information, e.g. based on data provided by the sensing devices, that includes a substantially real time view of the availability of parking (and routing thereto) throughout the deployment area of the distributed remote sensing system. The motorist unit may be configured to allow a user to select a location and see how full the parking spaces are in an area using, for example, color coded or other suitable indicators. Pricing to park in each parking space may also be provided. The way finding information provided by the motorist unit may also allow a user to keep track of where they park. In one aspect the motorist unit may include or be used in conjunction with a global positioning system or other mapping data to provide a user with traffic information related to the parking spaces so that the user can select, for example a parking lot exit or street that is not congested with vehicles leaving parking spaces monitored by the distributed remote sensing system.

As noted above the central controller 101 may be connected to the one or more gateways 110A-110C (and to the sensing devices) in any suitable manner. In one aspect one or more communicators 140 may be used as a communication link between the gateways 110A-110C and the central controller 101. The one or more communication links 140 may include, for example, one or more cell towers/providers in a cellular communication network. In other aspects the one or more communication links 140 may include, for example, one or more satellites in a satellite communication network, a public switched telephone network, Internet/World Wide Web access points or any other suitable communication access points such as those used in the wired and/or wireless communication protocols described above. In still other aspects the one or more communication links 140 may be a combination of cellular and satellite communication or any other suitable wired or wireless communication link.

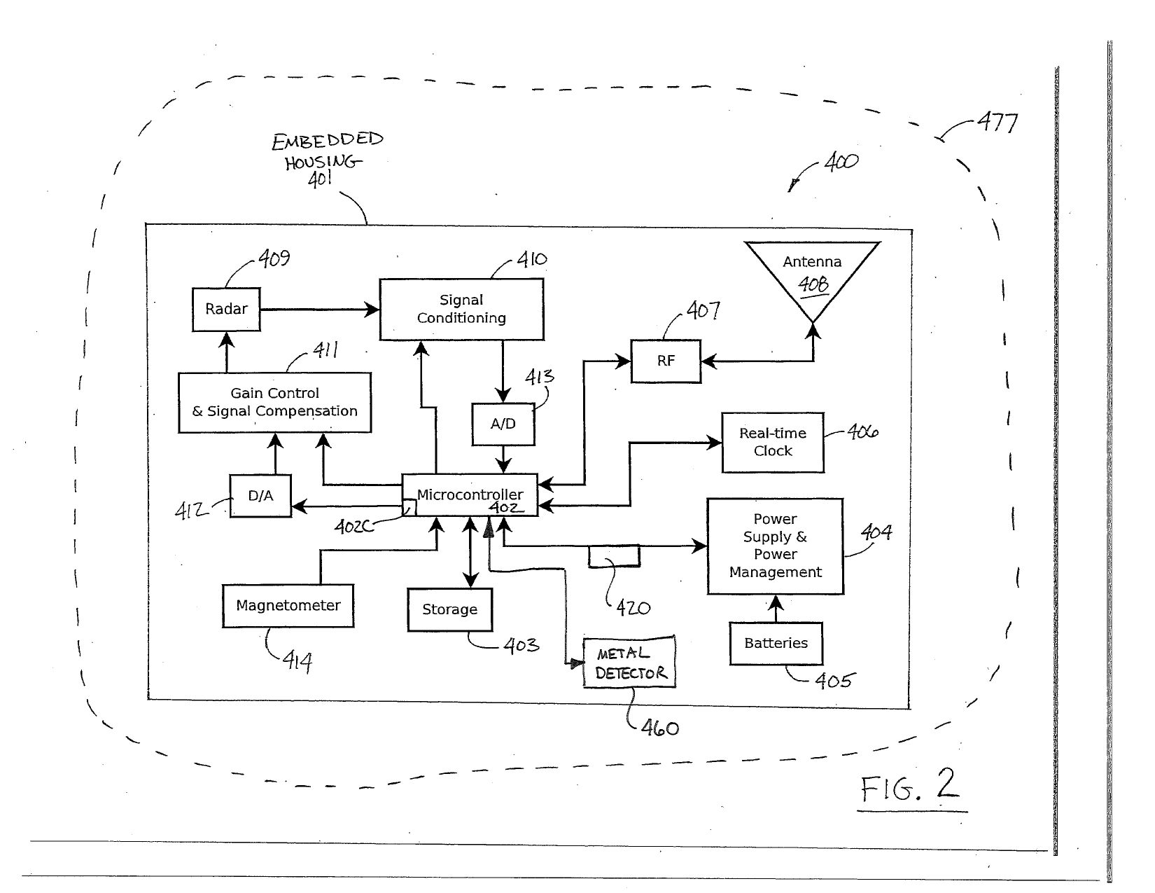

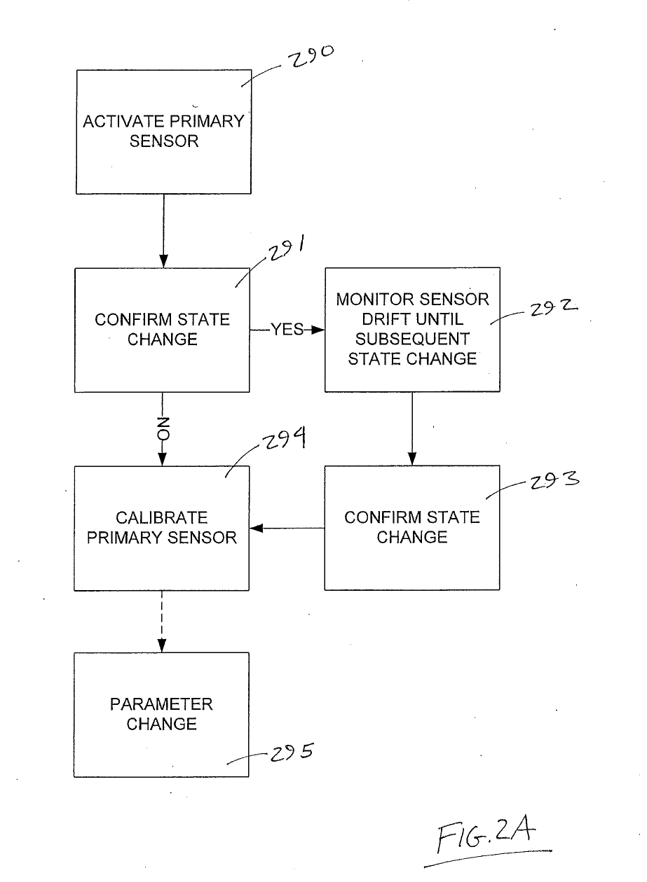

Each of the gateways 110A-110C may include any suitable housing 401 (see FIG. 2) having any suitable shape and size. In one aspect the housing 401 is weatherproof, tamperproof and may be UV (ultraviolet) ray resistant. The housing may be constructed of any suitable material so that, in one aspect, radio frequencies are allowed to pass through the housing. Each gateway 110A-110C (generally referred to as gateway 110) may include, e.g. within a respective housing, a processor module (which may include any suitable memory and suitable programming and may be configured for performing the functions of the gateway as described herein), GPS module, a clock module, a charge controller, a power supply module and any suitable number of communication modules.

Referring to FIG. 2 each sensing device 120A-120C, 121A-121C, 122A-122C in the groups 120, 121, 122 of sensing devices may be substantially similar to vehicle parking detector (also referred to as sensing device) 400. In one aspect the sensing device 400 may be a dual mode sensor (as will be described below) and include any suitable housing 401. The housing 401 may have any suitable shape and be constructed of any suitable material so that in one aspect the sensing device may be placed or otherwise embedded at least partly within the ground/roadway of a parking space or within the ground/roadway of navigable roadway (e.g. substantially below or substantially even with a driving surface of the parking space or navigable roadway). In another aspect the housing 401 may be configured for placement above ground at any suitable location for sensing vehicles in a respective parking space or navigable roadway. The housing 401 may be configured to house components of the sensing device 400 such as a processor/controller 402 (referred to herein a processor 402), memory 403 (which is suitably configured along with the processor 402 to effect the operational aspects of the sensing devices as described herein), sensor system clock 406, a sensor power system, a sensor communication system and any suitable vehicle detection sensors. In one aspect each sensing device may include dual timers such that each parking meter includes two clocks. In one aspect each sensing device includes the sensor system clock 406 as well as clock 402C which may be an internal clock of the processor 402. Here the sensor system clock 406 may be used to bring the sensing device 400 out of a sleep mode (e.g. wake the sensing device up at any suitable configurable time interval) for sampling a state (e.g. an occupied or positive state and a null or unoccupied state) of the parking space being monitored. It is noted that the sleep mode is when the sensing device is not transmitting or receiving information from the gateway. In one aspect the sensor system clock 406 may have any suitable resolution, such as for example about a 0.01 second resolution. The sensor system clock 406 may be operated to wake up the sensing device for communications/status updates with a gateway at any suitable configurable time interval and/or waking up for operation of, for example, the magnetometer 414 at any suitable configurable time interval (e.g. sensor cycling). When communications are to be transmitted and/or received (e.g. communication cycling), once the sensing device 400 is awake the internal clock 402C operates at any suitable resolution greater than the resolution of the sensor system clock 406, such as at for example, a resolution of about 125 nanoseconds. The internal clock 402C may be used to effect time frequency hopping for synchronizing communication between the sensing device 400 and a gateway or any other suitable time based operation or service of the sensing device. In other aspects the internal clock 402C may be configured to effect waking up the sensing device for communication cycling and/or sensor cycling. It is noted that the dual timers may effect at least two timing modes which include a first mode for waking up the sensing device at predetermined time intervals (where each predetermined interval may have a different periodic interval) and a second mode for waking up the sensing device for communications where the sensing device communication frequency is synchronized with the communication frequency of a gateway upon waking.

In one aspect the sensor power system may include a power supply and management unit 404 that is connected to the processor 402. Any suitable power storage unit(s) 405 may be connected to the power supply and management unit 404 for supplying power to the components of the sensing device 400. In one aspect a solar panel may be provided to charge the power storage unit and/or supply power to the power supply and management unit. In other aspects power may be provided through a hard line from a power utility company. The power supply and management unit 404 may be configured to regulate and distribute power from the power storage units 405 in any suitable manner, such as under the control of the processor 402. Any suitable switch 420 may also be provided to turn the power supply and management unit off so that no power is drained from, for example, the power storage unit(s) 405. In one aspect the switch 420 may be a magnetic switch such that when a magnet is placed on the outside of the housing 401 the switch is activated to turn the power off and when the magnet is removed the switch is deactivated and power is supplied to the components of the sensing device 400. The switch may allow the sensing device to be turned off while in storage/inventory before installation or at any other suitable time. The power supply and management unit 404 and/or the processor 402 may also be configured to track the current used by each of the sensing device 400 components. In one aspect the only current usage is tracked (e.g. not the amplitude of the current) when each component is on where the power supply and management unit 404 and/or the processor 402 calculates the expected current draw for each component and/or a total current draw for all components. The power supply and management unit 404 and/or the processor 402 accumulates or otherwise obtains the expected current consumption for all of the components and predicts an end of life for the power storage unit(s) 405. The sensing device 400 may be configured to transmit the expected end of battery life (e.g. in years, months, days, hours, minutes, seconds, or a combination thereof) to a user of, for example, a peripheral device 130-132 or the central controller 101 for predictive maintenance of the power storage unit(s) 405 and/or sensing device so that the power storage unit(s) and/or sensing device may be replaced before failure. The sensing device 400 and components thereof may be configured to draw a consistent current from the power storage unit(s) to improve battery life.

The sensor communication system may include a communication/radio module 407 (which may be any suitable radio frequency communication module) connected to the processor 402 and an associated antenna 408. The antenna 408 may be any suitable antenna such as in one aspect an omnidirectional antenna and in another aspect a directional antenna. Where the antenna 408 is a directional antenna suitable motors or other solid state or mechanical drive unit may be provided for swiveling or otherwise rotating the antenna so that a signal strength of a received or sent communication is maximized.

As noted above, the sensor 400 may be a dual mode sensor in that it has at least one passive vehicle detection sensor and at least one active vehicle detection sensor. In one aspect the passive vehicle detection sensor may be a primary sensor and the active vehicle detection sensor may be a secondary sensor as will be described below. In other aspects the at least one active vehicle detection sensor may be the primary sensor and the at least one passive vehicle detection sensor may be the secondary sensor. In one aspect the passive vehicle detection sensor may be any suitable omnidirectional vehicle detection sensor such as for example, a magnetometer(s) 414. In other aspects the passive vehicle detection sensor may be a capacitive sensor, inductive sensor or other suitable sensor. The magnetometer 414 may be a three dimensional magnetometer configured for omnidirectional vehicle detection that is set to a baseline configuration after installation where the baseline configuration may be used to reset the magnetometer to reduce sensor drift (as described herein). The active vehicle detection sensor may be, for example, a directed beam sensor such as radar sensor(s) 409. In other aspects the active vehicle detection sensor may be an infrared sensor, optical sensor, ultrasonic sensor or any other suitable sensor. As may be realized the active sensor (e.g. directed beam sensor) is disposed so that the combined dual mode sensor is omnidirectional. For example, the passive and active sensors may be mounted inside the housing 401 so as not to interfere with each other and be configured to be embedded in a driving surface and provide omnidirectional vehicle detection within a zone of sensitivity 477. It is noted the zone of sensitivity may have any suitable size and shape. The magnetometer 414 and radar sensor 409 may be connected to the processor 402 in any suitable manner and be configured to sense a vehicle individually (e.g. operate separately for redundancy such as when the magnetometer is not available—the processor may use either the radar sensor 409 or the magnetometer to sense the vehicle), in conjunction with each other (e.g. operate together), or according to any predetermined sequence of operation. For example, the radar sensor 409 may be used to verify the sensing activity of the magnetometer 414 or vice versa. In one aspect the magnetometer 414 and radar sensor 409 may operate periodically at any suitable time interval while in other aspects the magnetometer 414 and radar sensor 409 may operate continuously. As may be realized any suitable ancillary circuitry may be provided to allow communication of one or more of the vehicle sensors 409, 414 with the processor 402. For example, a digital to analog convertor 412 and/or a gain control and signal compensation module 411 may be provided for communications from the processor 402 to the radar sensor 409 while a signal conditioning module 410 and analog to digital convertor 413 may be provided for communication from the radar sensor 409 to the processor 402. In one aspect, a power efficient usage of the magnetometer 414 and the radar sensor 409 is the employment of the magnetometer 414 to trigger a radar measurement where the radar measurement may be of a higher quality/accuracy than the magnetometer measurement. This triggering or otherwise activation of the radar sensor 409 may reduce the over use of the radar sensor 409 thereby reducing overall power consumption of the sensor 400. The triggering of the radar sensor 409 by the magnetometer 414 may be limited to, for example, 30 second intervals (or any other suitable pre-programmed interval longer or shorter than 30 seconds) to save, for example, battery life of sensor 400 or otherwise reduce power consumption. In another aspect, a metal detector 460 may be used in addition to or in lieu of one or more of the radar sensor 409 and the magnetometer 414. For example, the metal detector 460 may be any suitable metal detector such as an induction metal detector, where any shift in measured permeability would indicate the presence of a vehicle above the sensor 400.

The primary and secondary sensors may produce a “null” signal to indicate that a vehicle is not present in the parking space being monitored and a “positive” signal to indicate that a vehicle is present in the parking space being monitored. At least the null and positive signals of the primary sensor may have an associated upper and lower range such that when the actual signal produced by the primary sensor is out of that range the secondary sensor may be used to re-zero or reset the primary sensor to baseline settings of the primary sensor. In one aspect the secondary sensor, such as radar sensor 409, may operate periodically to calibrate and/or re-calibrate the primary sensor such as the magnetometer 414. As may be realized, a magnetic sensor such as magnetometer 414 may drift, from baseline readings (e.g. due to changes in immediate surroundings and performance changes in the sensor itself), over time and produce variances in readings that may lead to inaccurate detection determinations (e.g. outside the upper or lower sensing limit). The radar sensor 409 may be used to detect whether a vehicle is present in the parking space being monitored by the sensing device 400. If the radar sensor 409 detects that there is no vehicle present, the magnetometer 414 may be reset to a predetermined magnetometer baseline setting. This re-zeroing or otherwise recalibration may be performed at any suitable time interval. This may be initiated by the sensing device or commanded by the central controller 101 through the gateway 110 according to a predetermined time(s) or on demand as desired. Recalibration settings, sampling times, threshold readings and tolerance bands thereof and any other suitable features, such as those described herein may be changed remotely by downloading from the central controller 101 through the gateway 110. For example, the magnetometer may be recalibrated every time the parking space is empty, every other time the parking pace is empty, every “X” number of times the parking space is empty (e.g. where X is any suitable integer) or when a reading of the magnetometer when the parking space is empty deviates from the baseline setting by a predetermined amount/threshold. In one aspect when the parking space being monitored is deemed to be empty by the radar sensor the sensing device 400 may be configured to automatically recalibrate the magnetometer 414. In another aspect, where the secondary sensor is not available an empty state of the parking space can be monitored in any suitable manner such as manually or by monitoring the output of the magnetometer 414. If the parking space is deemed to be empty either through manual operation or no substantial change in magnetometer output from the baseline setting over a predetermined period of time, the magnetometer may be re-zeroed manually or automatically.

Generally in operation, the primary sensor (e.g. magnetometer 414) may be activated periodically and/or upon arrival of a vehicle in the parking space being monitored (FIG. 2A, Block 290). The secondary sensor (e.g. radar sensor 409) may be activated to confirm a state change of the primary sensor (FIG. 2A, Block 291). If no state change has occurred the primary sensor may be recalibrated to baseline settings (FIG. 2A, Block 294). If a state change has occurred (e.g. a reading of the primary sensor is different than the baseline) a vehicle is present in (e.g. occupies) the parking space. In either state a minimization technique or algorithm may be used to remove variance in readout (e.g. sensor drift). This may be effected locally (e.g. at the sensing device processor 402) or at any suitable remote location such as at the central controller 101 or gateway 110. For example, where a vehicle is present in the parking space a least sum squares process may be used to monitor sensor drift until the parking space is empty (e.g. a state change is detected in the magnetometer reading) (FIG. 2A, Block 292) while in other aspects when a vehicle is not present in the parking space a least sum squares process may be used to monitor sensor drift until the parking space is occupied. The secondary sensor may be activated to verify the space is empty (e.g. verify a subsequent state change of the primary sensor) (FIG. 2A, Block 293) and if the parking space is confirmed empty by the secondary sensor the primary sensor is recalibrated to baseline settings (FIG. 2A, Block 294).

The magnetometer baseline settings are established and stored in, for example, a memory 403 of the sensing device 400 when, for example, the magnetometer 414 is initially installed or at any other suitable time. It is noted that the secondary sensor (e.g. radar sensor 409) may or may not be employed to obtain the baseline setting. It is noted that the baseline setting is a physical reading taken by the magnetometer at initial installation (or any other suitable time prior to commencing operation) and may account for most environmental influences on the magnetometer as well as removing uncertainty in sensing device 400 placement and orientation on startup. In operation, when a difference is measured between a magnetometer reading and the baseline the sensing device 400 detects that a vehicle is present/arrived in the parking space. The difference between the baseline and the magnetometer measurements may be derived in any suitable manner such as empirically, based on measured data across different types of cars. As may be realized, the distributed remote sensing system may record the car specific data in any suitable memory, such as the memory of the sensing device and/or central controller, the distributed remote sensing system can learn over time and improve the precision of the vehicle detection.

In another aspect the magnetometer 414 may verify that the radar sensor 409 is operating properly. For example, the magnetometer 414 may be tuned such that it is operable as a stand-alone vehicle detection sensor (e.g. substantially without radar verification). In this aspect the magnetometer 414 may detect the presence of a vehicle while the radar sensor 409 produces a null signal or does not detect the presence of a vehicle. The sensing device 400 may recognize the presence of the vehicle based on information provided by the magnetometer 414 and convey a vehicle presence to the central controller 101 through the gateway 140 along with an indication that the radar sensor 409 may be in need of maintenance or is otherwise inoperable. In one aspect a method for active sensor validation/verification may be substantially similar to that described herein with respect to FIG. 2A.

In still another aspect, in operation the sensing device 400 may be placed in a travel lane of a navigable roadway for use as a traffic lane detector to, e.g., monitor road use and traffic patterns or gather any other suitable information. Here the radar sensor 409 may operate substantially continuously. The processor 402 may be configured to receive and process information from the radar sensor 409 such that a number of vehicles passing over the sensing device 400 may be counted using, for example, a Doppler effect of the radar sensor 409 as the vehicles pass over the sensing device 400. Processing the sensor signal to account for the Doppler effect provides validation or confirmation of the vehicle passage and substantially prevents spurious data from affecting the vehicle count. The processor 402 may store vehicle count information (e.g. the number of vehicles that passed over the sensor) in any suitable memory such as memory 403 and effect transmission of the vehicle count information to the central controller 101 through the gateways 140. As may be realized, when traffic data is desired from any of the sensing devices 400 the desired sensing device may be so commanded from the central controller 101, during for example any suitable communication, to awake the radar sensor 409 and commence vehicle detection and counting for any suitable predetermined period. Upon expiration of the predetermined period the sensing device 400 may automatically stop vehicle counting or it may be commanded by, for example, the central controller 101 to stop vehicle counting such that the radar sensor 409 goes back to sleep. In one aspect the vehicle count information may be reset (e.g. so that the count is started over) at any suitable time. For example, the vehicle count information reset may be initiated at predetermined time intervals (or at any suitable time) by the sensing device 400 or remotely by, for example, one or more of the gateway 140 or central processor 101. In one aspect the vehicle count information may be gathered coincident with vehicle parking information to, for example, count a number of vehicles using a respective parking space.

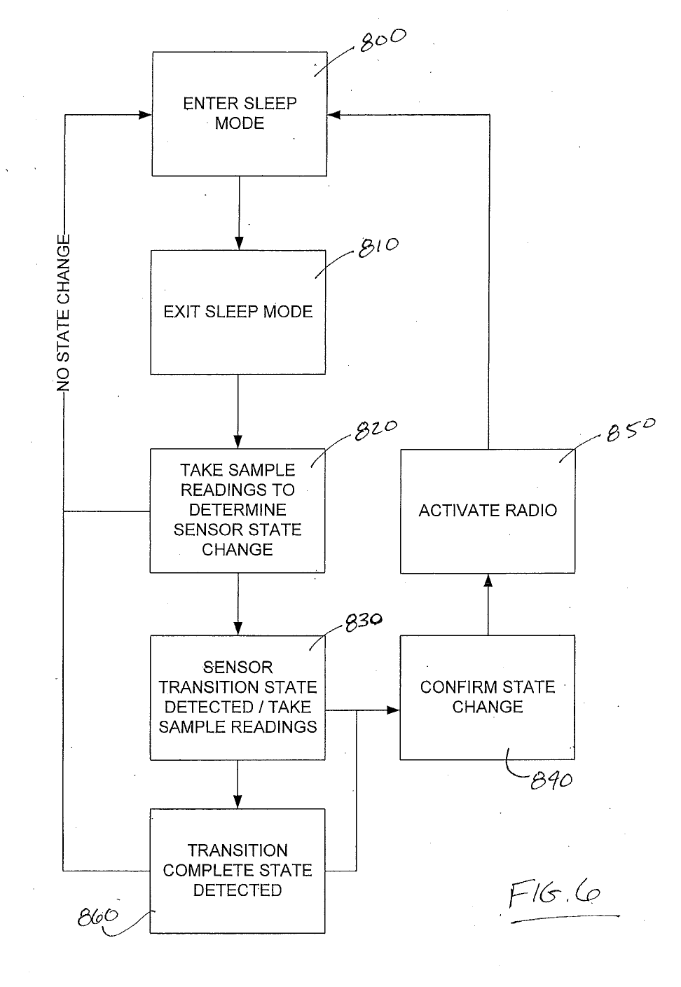

In one aspect the sensing devices 400 may have at least one sensing mode (e.g. duty cycle) in which the primary sensor (e.g. magnetometer 414) is cycled between on and off states to take sample readings of the parking space being monitored. It is also noted that the sensing devices 400 may be configured to enter the sleep mode (FIG. 6, Block 800) to conserve power. The sensing devices 400 may be configured to exit the sleep or idle mode (e.g. wake up) (FIG. 6, Block 810) at any suitable interval to take a magnetometer 414 readings (e.g. sample readings) or for any other suitable purpose. The rate at which the sensing devices 400 wake up for sampling a state of the parking space being monitored may be configurable on a per sensing device basis (or configurable as sensor groups) and has three duty cycles or components depending on whether the parking space being monitored is empty, occupied or transitioning between being occupied and empty or vice versa. In one aspect the sensing devices may wake up about every 4 seconds (or any other suitable time interval) when the parking space is occupied (e.g. the sensor produces a positive signal) to sample the state of the parking space, about every 8 seconds (or any other suitable time interval when the parking space is empty (e.g. the sensor produces a null signal) to sample the state of the parking space and about every 0.5 seconds (or any other suitable time interval) for sampling when the state of the parking space is transitioning between an empty state and an occupied state. It is noted that upon waking up only necessary components of the sensing device may be powered, such as for example, the processor 402, memory 403, magnetometer 414 and power supply and management unit 404. Power may be supplied to other components of the sensing device as needed or according to a predetermined sequence as noted below. Once a magnetometer reading is taken (FIG. 6, Block 820) and if a transition has not occurred the sensing device re-enters sleep mode (FIG. 6, Block 800). If the sensor is in a transition state (e.g. when the parking space being monitored is changing state between being occupied and empty or vice versa) the sensing device 400 takes “n” sample magnetometer readings (where “n” is any suitable integer—the number of samples taken is configurable). If a transition occurs and is detected (FIG. 6, Block 830) and/or is the completion of the transition is detected (FIG. 6, Block 860), the sensing device 400 activates the radar sensor 409 to confirm the state purported by the magnetometer 414 (FIG. 6, Block 840). It is noted that the radar sensor 409 may be activated periodically (e.g. such as after each sample reading taken by the magnetometer) to obtain sample readings for confirming a state change. If the state of the magnetometer 414 is confirmed the radio unit 407 of the sensing device 400 is turned on for communication with a gateway 110 (FIG. 6, Block 850) as described below where an appropriate communication channel is selected based on, for example, the time of and the last channel used. After a transmission is made or received the sensing device returns to the sleep mode (FIG. 6, Block 800). It is noted that when the sensing device enters sleep mode substantially all components of the sensing device are shut off at substantially the same time. As may be realized, for example, the system clock 406 may be configured to wake up the processor at any suitable interval for taking the magnetometer reading and/or for sending and receiving information.

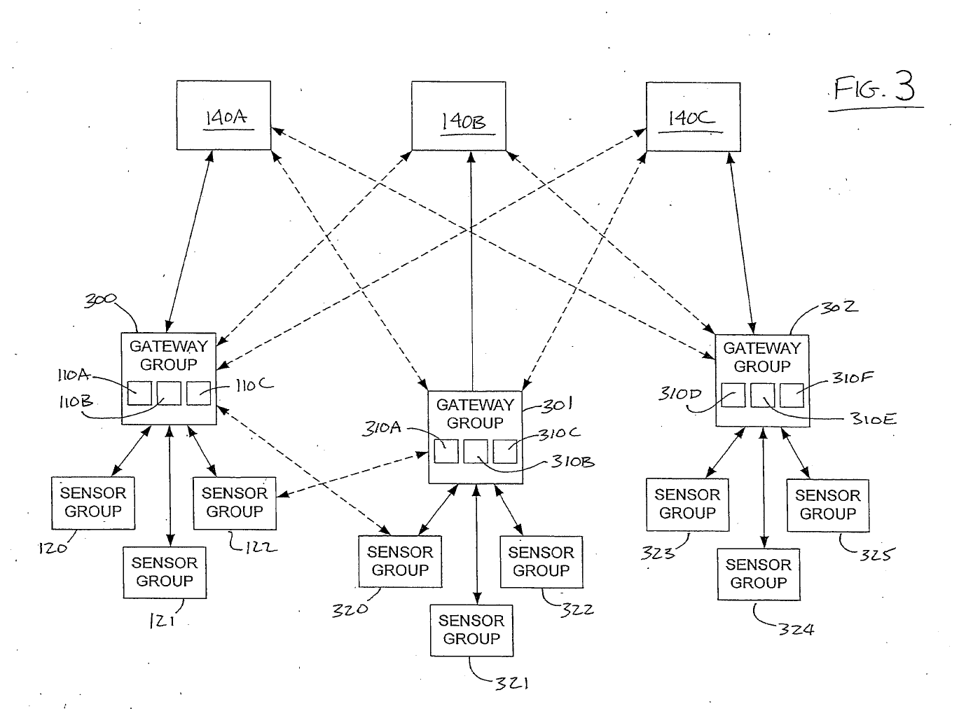

Referring again to FIG. 1 and FIG. 3, in operation, there may be groups of gateways 300-302 each having one or more gateways 110A-110C, 310A-C, 300D-310F where each gateway is in communication with the central controller 101 through, for example, one or more communicators 140 which in this aspect are cellular providers 140A, 140B, 140C. Using gateway group 300 and associated sensing device groups 120-122 as an example, several levels of redundancy may be provided for communication within the vehicle metering system 100. As will be explained in greater detail below there may be one level of redundancy with respect to communication between the sensing devices within the sensing device groups 120-122 and the gateways 110A-110C. There may be another level of redundancy between communications between the gateways 110A-110C and the communicators 140A-140C. There may also be a level of redundancy with respect to communications from the sensing devices where sensing device messages are stored within a gateway 110A-110C when one or more gateways and the communicators 140A-140C are unavailable.

As noted above, each gateway 110A-110C may be paired with its own group 120, 121, 122 of sensing devices. The sensing devices 120A-120C, 121A-121C, 122A-122C may be any suitable sensing devices such as those described in United States Provisional patent applications having U.S. provisional patent application Nos. 61/824,609 and 61/824,630 filed on May 17, 2013 (now United States non-Provisional patent applications respectively having attorney docket numbers 1195P014932-US(PAR) and 1195P014933-US(PAR) and filed on May 19, 2014), the disclosures of which are incorporated herein by reference in their entireties. In one aspect the sensing devices may detect the arrival and departure of vehicles within associated parking spaces. For example, as noted above, one or more sensing devices may be located (e.g. such as embedded in the road surface or otherwise) in each parking space monitored by the vehicle metering system 100. Each gateway 110A-110C in the group of gateways 300 may provide a redundancy for communication with the sensing device groups 120-122. In one aspect the gateways may be arranged or otherwise positioned throughout a deployment area of the vehicle metering system 100 so that each sensing device is capable of communicating with at least two gateways. As an example, gateway 110A may be paired as a primary gateway with sensing devices 120A-120C within sensing device group 120 (e.g. that define a primary sensing device group for gateway 110A) and paired as a secondary gateway with sensing devices within sensing device groups 121, 122 (e.g. that define secondary sensing device groups for gateway 110A). Gateway 110B may be paired as a primary gateway with sensing devices 121A-121C within sensing device group 121 (e.g. that define a primary sensing device group for gateway 110B) and paired as a secondary gateway with the sensing devices of sensing device groups 120, 122 (e.g. that define secondary sensing device groups for gateway 110B). Gateway 110C may be paired as a primary gateway with sensing devices 122A-122C within sensing device group 122 (e.g. that define a primary sensing device group for gateway 110C) and paired as a secondary gateway with sensing devices in sensing device groups 120, 121 (e.g. that define secondary sensing device groups for gateway 110C).

It is noted that a primary gateway is the gateway given priority when communicating with a respective primary sensing device group. Secondary gateways are configured to communicate with their secondary sensing device groups when the primary gateway for those secondary sensing device groups is unavailable. In other words, each gateway 110A-110C in the group of gateways 300 provides each sensing device in each primary sensing device group with a redundant gateway (e.g. if one of the gateways 110A-110C in the group of gateways 300 is unavailable the other gateways 110A-110C within that group of gateways are configured to allow communication with the sensing devices associated with the unavailable gateway). For example, if gateway 110A is unavailable, either one of gateway 110B or gateway 110C allows communication with the sensing devices of sensing device group 120. Each gateway 110A-110C within the group may be prioritized with each other with respect to the redundant communication. The prioritization for communication with a sensing device within a sensing device group 120-122 with a secondary gateway (e.g. which secondary gateway is chosen for communication and in what sequence) may be based on a proximity of a secondary gateway to the primary sensing device group for the unavailable gateway (e.g. so that the least amount of power is used by the sensing devices when communicating with the secondary gateway) or based on any other suitable criteria. In one aspect the gateways 110A-110C are configured to listen for messages from the sensing devices (e.g. primary sensing devices, secondary sensing devices or both) and when a message is received from a sensing device that message is acknowledged by the gateway so that there is an indication sent back to the sensing device that the message was received by the gateway. If the sensing device does not receive an acknowledgement message the sensing device then proceeds to communicate with each of the secondary gateways according to the gateway prioritization until an operational gateway acknowledges the sensing device message.

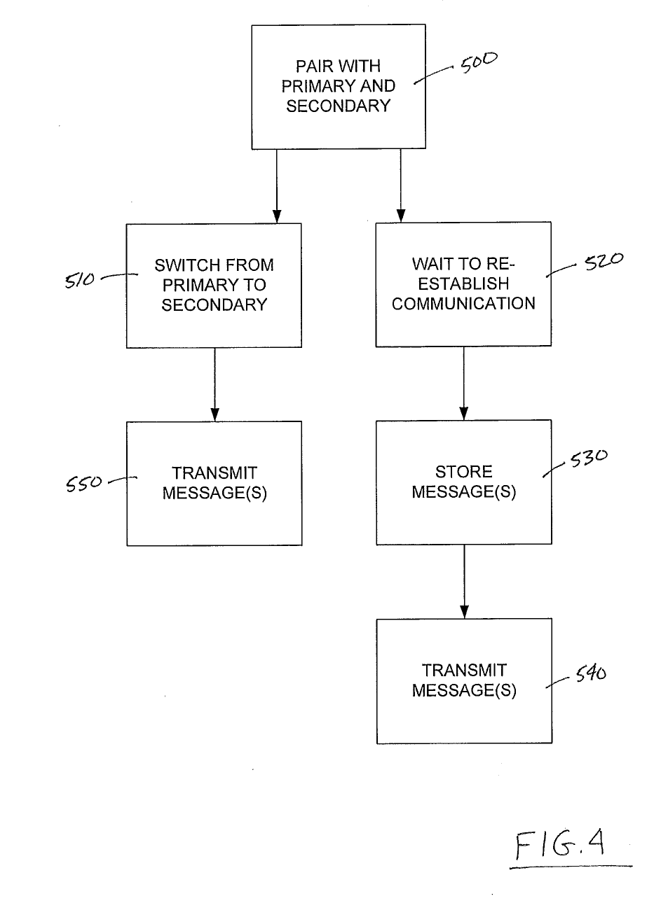

In a manner similar to that described above between the gateways 110A-110C and the communicators 140A-140C, the sensing devices 400 (FIG. 2) are paired with a primary gateway and at least one secondary gateway, e.g. in a respective gateway group or in another gateway group, in any suitable manner. For example, referring to FIGS. 1 and 4, sensing devices in sensor group 120 may have gateway 110A as a primary gateway and one or more of gateways 110A, 110C or 310A-310E as secondary gateways. In one aspect, the sensing devices 400 may be configured to automatically determine which gateway is to be the primary gateway based on any suitable criteria, such as for example, a communication signal strength between the sensing device and gateway and/or a distance between the sensing device and gateway (e.g. based on GPS information provided by the gateway). In other aspects the primary gateway may be manually selected in any suitable manner, such as through line of sight. The sensing device 400 may be configured to switch communications from the primary gateway to a secondary gateway in any suitable manner and at any suitable time such as when communication between the primary gateway and one or more communicators is unavailable and/or when the primary gateway is unavailable or when communications with the primary gateway are crowded. Selection of a secondary gateway by the sensing device 400 can be based on any suitable priority or criteria similar to that described above with respect to the gateways selecting secondary communicators (e.g. the sensing device may look for the best communication between the sensing device and the gateway). In other aspects where there are no gateways available the sensing devices 400 may be configured to time stamp and store any suitable parking data in the memory 403 and transmit the stored data when communication a gateway 110 is re-established as will be described in greater detail below.

In one aspect the gateways 110A-110C may be able to communicate with the sensing devices and provide health and welfare messages to the sensing devices regarding an operational state of the gateway. If one or more sensing devices receive a message from a gateway (either primary or secondary) that the gateway is unavailable for communication the one or more sensing devices receiving that message may switch to a secondary gateway and transmit messages to a selected available gateway. The health and welfare message may also be sent to the central controller 200 for system management and monitoring where any unavailability in the system may be addressed by maintenance personnel.

As noted above and still referring to FIG. 3, each sensing device may also be configured to communicate with the central controller 101 (FIG. 1) through one or more gateways 110A-110C, 310A-310E which in turn communicate with communicators 140A-140C. In one aspect the communicators may be cellular providers. Cellular provider as used herein may refer to a cellular network access point and/or cellular carrier. In other aspects any suitable communication protocols may be used as mentioned above, where each form of communication has one or more access points available to the gateway groups 300-302 and/or sensor groups 120-122, 320-325. In still other aspects each gateway may be connected to one or more communicators 140A-140C and each sensing device may be connected to one or more gateways over different communication protocols. For example, gateways in group 300 may be connected to communicator 140A over a cellular connection, connected to communicator 140B over a public switched telephone network and connected to communicator 140C over a network connection such as the World Wide Web. Similarly, as an example, sensor 120A may be connected to gateway 110A over a cellular connection, connected to gateway 110B over a public switched telephone network and connected to gateway 110C over a network connection such as the World Wide Web. Each sensor group 120-122, 320-325 may be associated or otherwise paired with a predetermined (e.g. a primary) one of the gateways 110A-110C, 310A-310E. For example, the pairing between the sensing devices and each gateway in the groups of gateways 300-301 may be based on, for example, proximity (e.g. so the least amount of power may be used for communication) between each sensing device and the gateway or any other suitable criteria. As may be realized, one gateway may serve as a primary gateway for more than one sensing device and/or sensor group. Using sensor group 120 as an example, each sensing device 120A-120C may be capable of communicating with at least two gateways to provide a level of redundancy in the vehicle metering system 100. As an example, referring to FIG. 3, a sensing device 120A-120C in sensor group 120 may be paired with gateway 110A as a primary gateway and with one or more of the gateways 110B, 110C, 310A-310E as secondary gateways (FIG. 4, Block 500) which may be prioritized for access in a manner similar to that described above (e.g. based on proximity so that the lowest power is used by the sensing device for communication with the gateway, preference of communication protocol—e.g. wired or wireless, etc.). In one aspect, the sensing devices may be configured to determine the proximity of each gateway to the sensing device and communicate with the closest available gateway to effect power consumption efficiency of the sensing device. Preference may be given to the primary gateway by the sensing device when communicating with the central controller 101. If the primary gateway is unavailable the sensing device may switch communications to communicate with a secondary gateway according to any suitable predetermined priority (which may be stored in the sensing device memory) of the secondary gateways until an available gateway is found (FIG. 4, Block 510) (e.g. the sensing device may look for the best communication between the sensing device and a gateway) and transmit one or more messages to the available gateway (FIG. 4, Block 550). As may be realized the sensing device may be configured to receive an acknowledgment message from the gateway and if that acknowledgement message is not received the sensing device may then proceed to communicate with the other (e.g. secondary) gateways.

In another aspect a sensing device may not switch gateways if its primary gateway becomes unavailable where the sensing device is configured to wait to re-establish communication with its primary gateway (FIG. 4, Block 520). In one aspect the sensing device may be configured to wait a predetermined length of time before switching between gateways. Here, there may be a level of redundancy with respect to communications from the sensing devices where sensing device messages are stored within the respective sensing device when one or more gateways are unavailable. In one aspect, using sensing device 120A as an example, sensing device 120A may establish communication with gateway 110A (which may be the primary gateway for sensing device 120A). If the gateway 110A becomes unavailable the sensing device 120A may store messages within a memory of the sensing device 120A (FIG. 4, Block 530). The sensing device 120A may monitor the availability of the primary gateway 110A and transmit the stored messages when the sensing device 120A re-establishes communication with the primary gateway 110A. Each message stored by the sensing device 120A is given a time stamp indicating when the message was created by the sensing device 120A so that, for example, the arrival, departure, violation, and other messages from the sensing devices can be accurately tracked and applied to user accounts by the central controller 101. When communication is re-established with the gateway 110A the sensing device 120A transmits the message with the time stamp to allow the central controller 101 to monitor the activity of the corresponding parking spaces (FIG. 4, Block 540).

In one aspect each of the sensing devices 120A-120C, 121A-121C, 122A-122C communicates with their respective gateway 110A-110C over any suitable wired or wireless communication interface (that e.g. may be substantially similar to that described above between the gateways and the communicators) in a time division duplexing (TDD) manner using a pseudo random channel sequence. For example, the sensing devices 400 may initiate a message (e.g. that includes data embodying a status of a parking space being monitored and/or a health and maintenance status of the sensing device) that requires or otherwise results in a response from a gateway 110 (either primary or secondary gateway), and sleeps or otherwise removes itself from active engagement with the gateway 110 until the sensing device 400 determines that it is time to ready itself for communication with the gateway 110. In one aspect the gateway 110 and the sensing device 400 may communicate over a wireless communication link where the transmission of messages and responses can be sent over any of a plurality of available transmission frequencies.

In one aspect, each gateway 110A-110C may transmit continuously using TDD and may be capable of changing communication channels/frequencies (it is noted that the terms channel and frequency are used interchangeably herein) according to a predetermined channel/frequency switching/hopping scheme (e.g. channel hopping as described above). It is noted that each gateway may have a respective channel/frequency switching scheme that is different from the channel/frequency switching scheme of other gateways. The gateway 110 may hop between any suitable number of frequencies when communicating with the sensing devices 400 over any suitable frequency band. In one aspect, as an example, the gateway 110 may hop between 50 frequencies over a frequency band of 902 Mhz to 928 Mhz while in other aspects the number of frequencies may be more or less than 50 and the frequency band may be higher or lower than 902 Mhz to 928 Mhz. In one aspect with each channel change, an outgoing message is transmitted by the gateway 110A-110C and then the gateway 110A-110C listens for response messages from the respective sensing devices 120A-120C, 121A-121C, 122A-122C. As such, at any given time the sensing devices 120A-120C, 121A-121C, 122A-122C are communicating with each of the respective gateways 110A-110C (e.g. primary and secondary) over a common communication channel. In one aspect the channel rate change may be, for example, approximately 100 mSec and the outgoing message from the gateway 110A-110C may use approximately 40% of the channel communication window allowing for long sensing device response times. In other aspects the channel rate change may be any suitable time interval (e.g. more or less than 100 mSec) and the outgoing message may use any suitable percentage of the channel communication window. Each gateway 110A-110C may be configured with any suitable number of channel hopping sequences such as for example, 256 channel hopping sequences. Each gateway may also be assigned any suitable address identifier such as, for example, a 16 bit address identifier that is unique to each gateway 110A-110C. Each gateway 110A-110C may be configured to broadcast its unique address identifier in, for example, the outgoing message so that the sensing devices may listen for the address identifier and determine which gateway 110A-110C they can communicate with. As may be realized the channel hopping sequences of the gateways may be known by the sensing devices. The sensing devices may be configured to listen for messages from the gateways and once a message is heard the sensing device receiving the message decodes that message and looks for an available time slot to transmit. When appropriate, the sensing device transmits a message to the gateway and waits for a response, which should be received substantially immediately. If the sensing device does not receive a response it resends the message a predetermined number of times. If not response is received after the message is sent the predetermined number of times the sensing device switches communications to a different gateway as described herein. Once the transmission is completed the sensing device may return to a sleep mode. Once communication is established between the gateway 110A-110C and the respective sensing device(s) 120A-120C, 121A-121C, 122A-122C predetermined parameters of the gateway (such as, e.g., the address identifier and channel hopping sequence) that are needed by the sensing devices for communication with the gateway may be updated at any suitable time such as on an as needed basis or at any suitable predetermined time frequency.

In one aspect the gateway 110A-110C may be configured for adaptive channel/frequency hopping so that a channel is changed and/or avoided when, for example, an error rate for particular channels exceeds a predetermined error rate threshold. As an example, if there is a frequency jam or other error the gateway is configured to select a new channel/frequency to be used in the hopping sequence. It is noted that in one aspect all of the gateways in a gateway group transmit messages substantially at the same time and listen for messages from the sensing devices substantially at the same time to, for example, reduce a possibility of self jamming. In other aspects any number of the gateways in the distributed remote sensing system may transmit at substantially the same time and listen substantially at the same time to, for example, reduce a possibility of self jamming. Similarly it is noted that any suitable number of sensing devices 400 may communicate with the gateways at substantially the same time. The gateway 110A-110C may send a “next hop index” message in every time slot of the outgoing message such that, when compared to a hop index of the sensing devices 120A-120C, 121A-121C, 122A-122C, the next channel being “hopped to” should match in both the gateway hop sequence index and a sensing device hop sequence index. In one aspect several spare channels known to both the gateway 110A-110C and their respective sensing devices 120A-120C, 121A-121C, 122A-122C may be available. The gateway 110A-110C may be configured to dynamically direct the sensing devices to select the spare channel, if that spare channel is a valid spare for the particular channel hopping sequence.

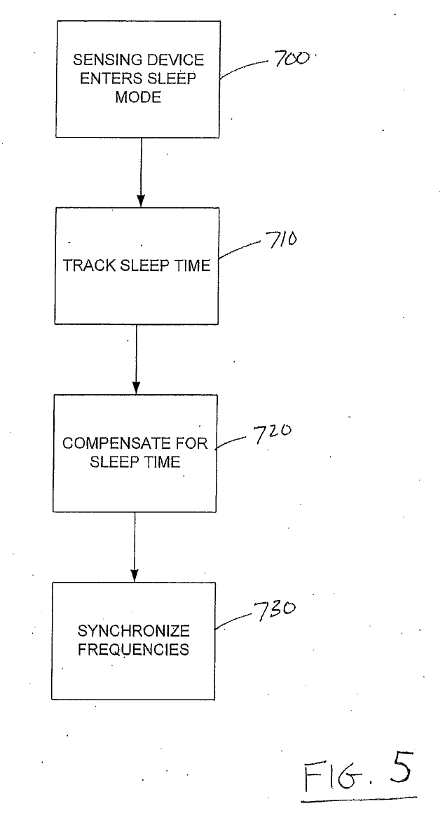

In one aspect, as noted above, the sensing devices 400 may be configured to sleep or otherwise deactivate one or more components to, for example, conserve power. As may be realized, when communicating with the pseudo random channel sequence the frequencies of the sensing devices 400 and the gateways 110 must match for communication to occur between the two. In one aspect, a sensing device 400 may sleep for a predetermined period of time (FIG. 5, Block 700) and when the sensing device 400 wakes up it must synchronize with the hopping frequency of the gateway 110. Here the sensing device 400 is configured to track the period of time the sensing device has been asleep (e.g. the sleep time) in any suitable manner such as by using, e.g., the internal clock 402C (FIG. 5, Block 710) and is configured upon waking to look forward an amount of time substantially equal to the sleep time, e.g. to compensate for the sleep time, (FIG. 5, Block 720) so that the frequencies of the sensing device 400 and the gateway 110 are synchronized for communication (e.g. the sensing device picks the active frequency of the channel hopping sequence upon waking from sleep) substantially immediately upon waking so that real time data may be provided by the sensing device 400 (FIG. 5, Block 730). In one aspect to facilitate the frequency synchronization the frequency hopping scheme of one or more gateways 110 may be stored within, for example, the memory 403 of the sensing devices 400. In one aspect the frequency hopping scheme and/or internal clock 402C (as well as sensor system clock 406) may be updated and in the case of the clock 402C synchronized with the clock 204 of the gateway at any suitable time intervals when communication is established between the primary and/or secondary gateways and the sensing devices. In one aspect the internal clock 402C may be synchronized with the gateway clock 204 at every transmission from the gateway (e.g. a current time of the gateway is sent to the sensing devices substantially every time the gateway sends a transmission to the sensing devices).

In one aspect the sensing device may be remotely configurable and/or updateable, e.g. through an interface between the gateways 110 and the respective sensing devices 400 where any suitable predetermined characteristic of the sensing devices 400 may be updated or configured/re-configured. In one aspect the predetermined characteristic may include a firmware version, one or more of a frequency hopping sequence for the communication interface, days of sensing device operation, hours of sensing device operation, a radar sensor strength, a magnetometer sensitivity, a magnetometer calibration and other configurable sensing device settings as described herein. As may be realized the configuration updates of each sensing device 400 may be effected from, for example, the central controller 101 (FIG. 1) in any suitable manner such as automatically or initiated by a user of the central controller.

The communication interface between the sensors 400 and the gateways 110 also allows health and welfare signals to be shared between the gateways and sensing devices. In one aspect the sensing devices 400 may wake up to send a health and welfare message to a respective gateway at any suitable predetermined time intervals which may be tracked by, for example, the system clock 406. For example, in one aspect the health and welfare messages may be sent substantially every 30 minutes while in other aspects the health and welfare messages may be sent at intervals that are less than or greater than 30 minutes. Once the health and welfare message is transmitted the sensing device may return to a sleep mode. The sensing device may also use the time it is awake (e.g. for sending the health and welfare message) to scan a status of the gateways with which the sensing device is able to communicate with. In still another aspect the health and welfare message may also include an occupancy status of a respective parking space being monitored by the sensing device 400. Where the sensing device is in high traffic areas and a high number of occupancy transitions within the respective parking space are keeping the sensing device 400 from sleeping the sensing device 400 may be configured to turn itself off (e.g. go to sleep) to conserve power. The gateways 110 may also send health and welfare messages to the respective sensing devices 400 so that the sensing devices 400 may switch to a secondary gateway if the primary gateway is not capable of transmitting messages from the sensing devices to the central controller 101 (FIG. 1).

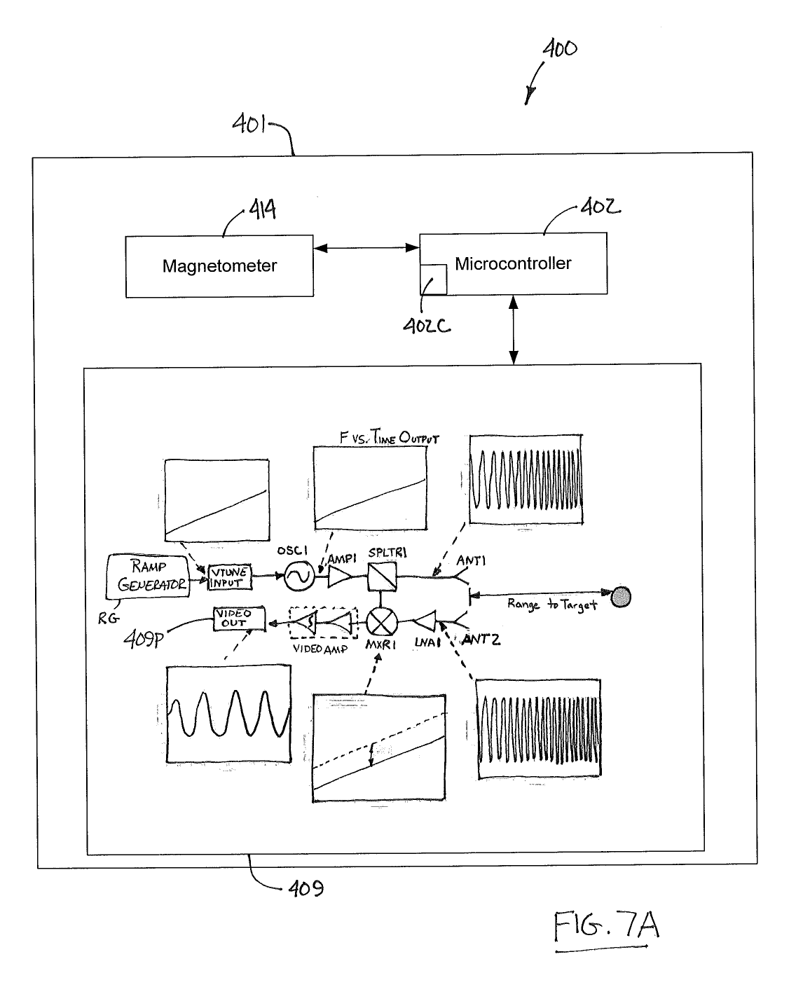

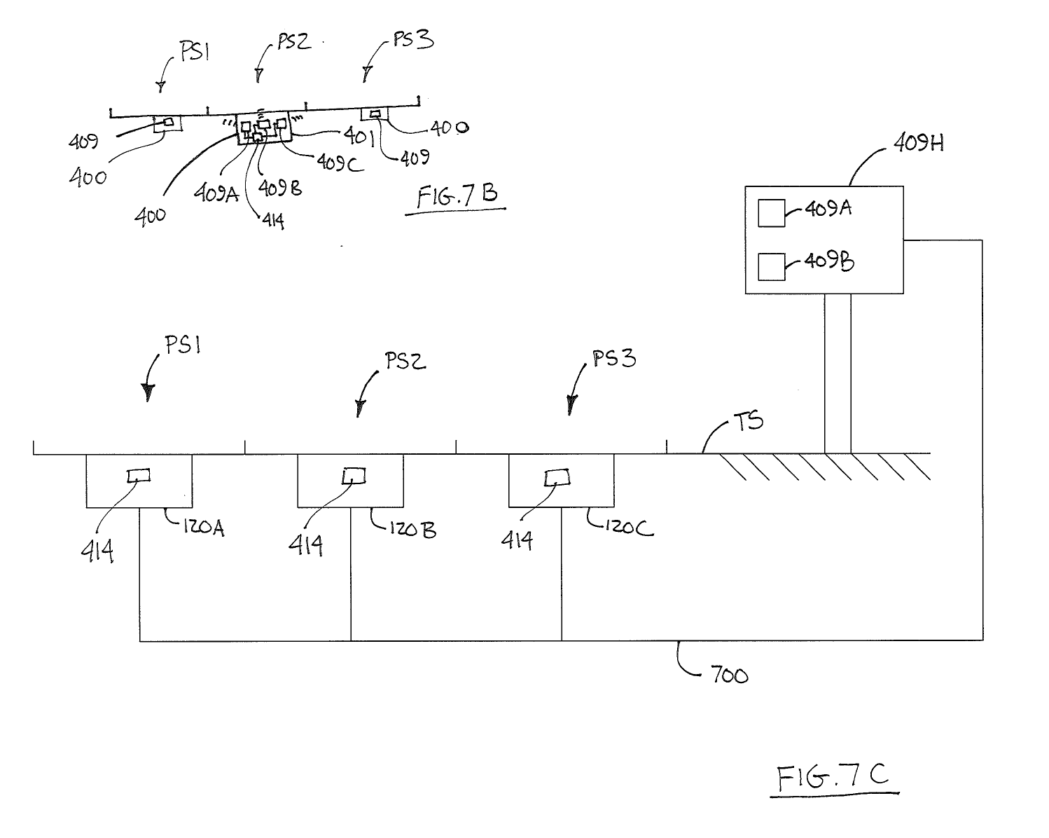

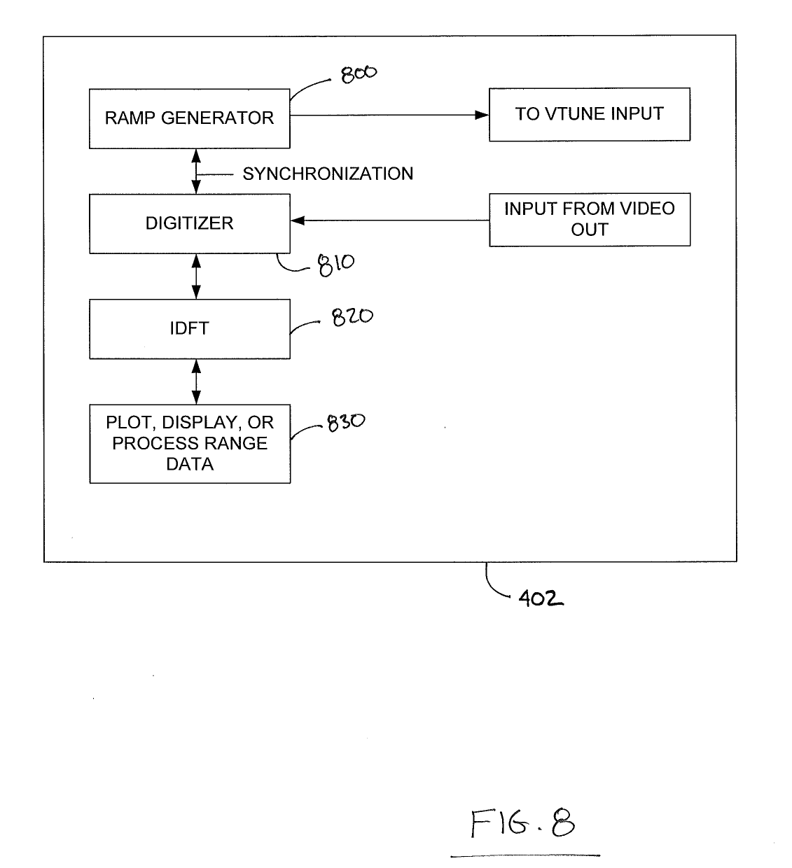

FIG. 7A is a schematic illustration of a portion of a vehicle metering system, such as the vehicle metering system described above with respect to FIGS. 1 and 3, in accordance with aspects of the disclosed embodiment. It is noted that the schematic illustration in FIG. 7A is a representative in nature and in other aspects the vehicle metering system may have any suitable configuration. Here the vehicle parking detector 400 (also referred to as sensor 400, as noted above), may be considered a ground level micro radar parking sensor that is similar to that described above with respect to FIG. 2, includes any suitable directed beam sensor, such as the radar sensor 409, magnetometer 414 and processor 402 (only the radar sensor 409, magnetometer 414 and processor 402 are illustrated for clarity). The radar sensor 409 may be any suitable type of micro radar sensor that has a low operating frequency and low battery consumption such as a phase coherent radar sensor including but not limited to continuous wave radar sensors, a frequency modulated continuous wave radar sensors or a pulse wave (impulse) radar sensors with phase coherent processing. For exemplary purposes only, the radar sensor 409 may be a low frequency radar sensor where low frequency is less than about 1 GHz, such as for example in the A or B radar bands, to effect low power/battery usage (high frequency radar may be considered to be above about 1 GHz). In one aspect it may be 180 MHz but any suitable low frequency may be used. It is noted that the radar sensor 409 may be an active sensor as described above. It is noted, as will be described below, that the processor may be configured for phase coherent processing of the radar sensor 409 output signals. The output signals may have both phase and amplitude differentiation in both a frequency domain and a time domain. In one aspect the time domain may be of a common signal pulse of the radar sensor. In another aspect the time domain may span over different signal pulses of the radar sensor.

As can be seen in FIG. 7A the sensor 400 is a dual or multiple mode sensor that includes different types of sensors in the common housing 401. In other aspects the sensor 400 may have only one sensor mode or type, such as a radar sensor as described herein. In the case of a multiple more sensor, for example, the housing 401 may enclose the low frequency micro radar sensor 409 and other vehicle detection sensors (such as the magnetometer 414 and/or metal detector 460—see FIG. 2) within the common housing 401. In other aspects the sensor may include one or multiple sensors of the same type. For example the housing 401 may house multiple radar (e.g. directed beam) sensors 409 arranged in the housing so that each radar sensor 409 within the common housing is directed to a respective parking space. For example, referring to FIG. 7B a common housing 401 of the sensor 400 includes radar sensors 409A, 409B, 409C (which are all substantially similar to radar sensor 409). Radar sensor 409A may be arranged within the housing 401 so as to detect vehicles in parking space PS1, radar sensor 409B may be arranged within the housing to detect vehicles within parking space PS2 and radar sensor 409C may be arranged within housing 401 to detect vehicles in parking space PS3. In one aspect, where multiple radar sensors 409A, 409B, 409C are located within a common housing 401 each of the radar sensors 409A, 409B, 409C may be communicably coupled to at least one associated sensor of a different type (such as e.g. magnetometer 414) so that in combination the multiple radar sensors 409A, 409B, 409C and the magnetometer 414 provide a dual or multiple mode sensor for each parking space PS1, PS2, PS3. In accordance with another aspect, the sensor housing 401 may have only a single radar sensor similar to sensor 409 covering multiple vehicle parking spaces and provide spatial resolution for detecting discrete vehicle presence respectively in each of the parking spaces as will be described further below.

The housing 401 (and the sensors therein) may be placed at ground level so that the housing 401 is embedded within, partially embedded within or disposed on/above any suitable surface, such as a travel surface of a parking area or navigable roadway as described above, for sensing vehicles in a respective parking space or navigable roadway (e.g. the housing is connected to the respective parking space or navigable roadway, see also for example, FIG. 2). In one aspect, there may be at least one radar sensor 409 corresponding to each vehicle parking space PS1, PS2, PS3 (See FIG. 7B). In other aspects, a radar sensor in one parking space PS2 may also detect discrete vehicles in adjacent parking spaces PS1, PS3 (i.e. each radar sensor corresponds to or detects vehicles in each discrete parking spot).

In other aspects, referring to FIG. 7C one or more radar sensors 409A, 409B may be disposed in one or more housing 409H that are placed at ground level above (or in any other suitable spatial relationship with), for example, the vehicle travel surface TS. The one or more radar sensors 409A, 409B may be arranged in the one or more housing 409H so that each of the radar sensors 409A, 409B is directed toward a predetermined portion of a parking area in a manner similar to that described above with respect to FIG. 7B. The one or more radar sensors 409 may be communicably connected to respective sensors 120A, 120B, 120C (similar to sensor 400) which are located in a respective vehicle parking space PS1, PS2, PS3 so that the one or more radar sensor 409 within the one or more housing 409H is common to one or more of the sensors 120A, 120B, 120C. Each of the multiple radar sensors 409A, 409B may be communicably coupled to at least one associated sensor of a different type (such as e.g. magnetometer 414) within one or more of the sensors 120A, 120B, 120C so that in combination the multiple radar sensors 409A, 409B and the magnetometer 414 provide a dual or multiple mode sensor for each parking space PS1, PS2, PS3. Here the one or more radar sensor 409 may be connected to respective sensors 120A, 120B, 120C through any suitable wireless or wired communication link 700. The communication link may be any suitable wired connection (e.g. public switched telephone network, Ethernet, local area network) or any suitable wireless connection (e.g. radio frequency, Bluetooth, cellular, satellite) or the communication link 700 may be through any suitable network such as the Internet or world wide web. Data acquired by the one or more radar sensor 409 may be transmitted to the respective sensors 120A, 120B, 120C over the communication link 700 for processing by, for example, the processor 402 which then transmits parking data to the central controller 101 in a manner substantially similar to that described above. In other aspects the one or more radar sensors 409 may be in communication with the central controller 101 which may gather data from one or more radar sensors and corresponding data from a respective sensor 120A, 120B, 120C for determining parking data.

In one aspect, referring again to FIG. 7A the at least one directed beam sensor (such as e.g. the low frequency micro radar sensor 409) of the sensor 400 may include moving target processing (e.g. through processor 402 or any other suitable processor such as a processor of the radar sensor 409) that effects high frequency radar sensitivity in a manner described herein. In one aspect the radar sensor 409 may be configured so that the output signal pulse is fed (e.g. from the Video output port 409P) to, for example, the processor 402 is a phase coherent signal defining a spatial frequency return signal of the directed beam sensor. I In one aspect as will be described further below, processing of the spatial frequency signal may employ both amplitude and phase differentiation and summation/averaging to effect moving target resolution in vehicle detection or determination of vehicle presence in discrete vehicle parking spaces adjacent to each other. In other aspects the spatial frequency signal processing may employ either one of amplitude and phase differentiation. Thus, the processor 402 may be configured to effect phase coherent processing of return waveforms where, in one aspect, the phase coherent processing includes both phase and amplitude differentiation and may also include summation over a complex time domain as further described herein.

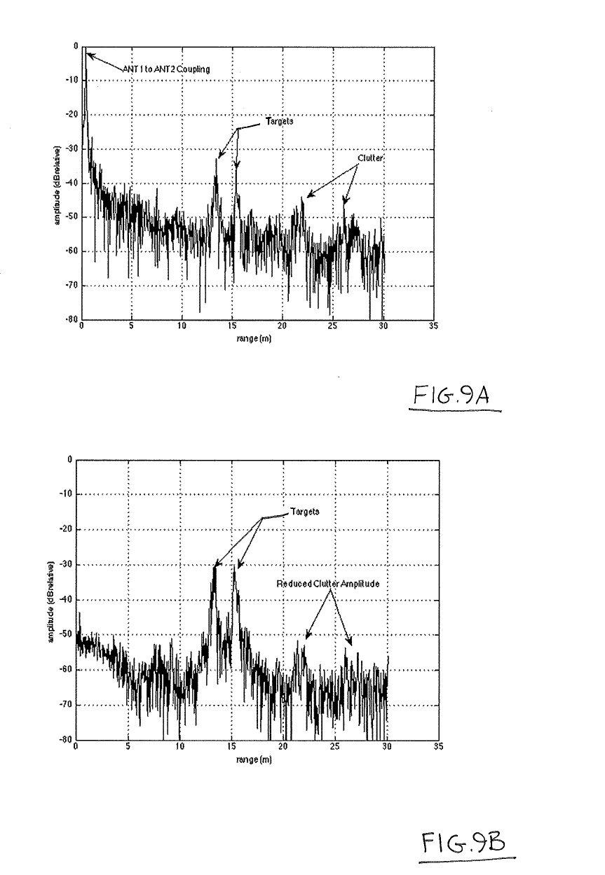

Also referring to FIG. 8, in one aspect where the radar sensor 409 is a frequency modulated continuous wave radar sensor, the frequency modulated continuous wave allows for radar ranging at a low cost with a very basic architecture (low cost in that it does not require generation or data acquisition of ultrawideband impulses). In frequency modulated continuous wave radar a voltage controlled oscillator OSC1 is ramp-modulated by a ramp generator RG (FIG. 8, Block 800). The ramp generator RG may be controlled in any suitable manner such as by processor 402. It is noted that the voltage controlled oscillator OSC1 may have an RF output that is a linear function of its tuning voltage Vtune input. The output of the voltage controlled oscillator OSC1 may be a frequency varying in time according to the modulation. This waveform is amplified by amplifier AMP1, split by a power splitter SPLTR1 and radiated out transmit antenna ANT1 towards a target scene such as a parking space or parking area. As may be realized, it may take time for the transmitted waveform to propagate from the antenna ANT1 to the target (such as a vehicle) and back to a receiver antenna ANT2. This round-trip time may delay the frequency varying waveform in proportion to a target distance and wave propagation velocity. This scattered signal (e.g. the return signal reflected off of the target) is collected by the receiver antenna ANT2, amplified by a low-noise amplifier LNA1, and fed into a frequency multiplier (or mixer) MXR1. Within the mixer MXR1, the original waveform from the splitter SPLTR1 is multiplied by the scattered waveform (which is also delayed in time). After multiplication, the slight frequency difference due to the delayed waveform (e.g. a phase differential) being multiplied by the reference waveform produces a single-frequency or beat tone. This single frequency is proportional to delay and therefore proportional to range. It is noted that the further the target is away from the radar sensor 400 the higher the beat tone will be. If multiple targets are present then multiple beat tones are superimposed on each other, providing a spatial frequency representation of a target scene (see FIGS. 9A and 9B described below). As may be realized, frequency modulated continuous wave data may be in the spatial frequency domain. The output of the mixer MXR1 may be amplified and filtered (low-pass filter for anti-aliasing purposes) by a video amplifier and fed to a digitizer (FIG. 8, Block 810) through a Video Out port 409P of the sensor 400. Analog data from the Video Out port is digitized in any suitable manner. A finite number of samples may be acquired within a common pulse where the finite number of samples is identical in duration to the time duration of the ramp modulation. In one aspect, the ramp modulation maybe synchronized to digitization (see FIG. 8) to effect coherent change detection, or in other words moving target processing, as will be described below. To convert FMCW radar data from the spatial frequency domain to the time domain an inverse discrete Fourier Transform (IDFT) is applied to samples of data (FIG. 8, Block 820). This time domain signal represents the range to all targets within a scene. The results of the inverse discrete Fourier Transform may be presented or processed in any suitable manner (FIG. 8, Block 830), such as by controller 402 to identify occupied or unoccupied parking spaces.

Referring now to FIG. 9A an example of a time domain (or range to targets) processed signal (such as from FIG. 8, Block 830) is shown. Here two targets (such as vehicle in a parking area) are in scene and are shown in addition to several sources of non-moving (stationary) clutter. These sources of clutter include trees or other things in the field of view of the radar sensor 409. It is noted that there may be a coupling between the transmit and receive antennas ANT1, ANT2 manifesting itself as the strongest target return at about the 0 range. As may be realized, when detecting parked cars it is desirable to range down to a near 0 distance from the radar sensor 409. This may be problematic when using low-cost (i.e. low frequency micro radar) frequency modulated continuous wave radar devices because these devices suffer from the direct transmit-to-receive coupling illustrated in FIG. 9A. In accordance with one aspect of the disclosed embodiment the post processing of the scattered waveform, received by the radar sensor 409, results in what may be referred to as a pulse compression effect from a low-cost micro radar sensor 409 overcoming the transmit to receive coupling effects sufficiently to provide sensitivity to near 0 range (as will be described further below). Accordingly the low-cost micro radar sensor 409 is in effect a pulse compression radar device. In one aspect the transmit to receive coupling illustrated in FIG. 9A may be reduced or eliminated by configuring, for example, the processor 402 with a pulse-to-pulse active or dynamic coherent change detection (or moving target resolution/indication) algorithm or programming. Referring now to FIG. 9B, the same data from FIG. 9A may be re-processed or post processed using coherent change detection (e.g. phase coherent processing) so that the 0 range return is substantially eliminated, clutter is reduced, and the target returns are significantly higher relative to the noise floor.

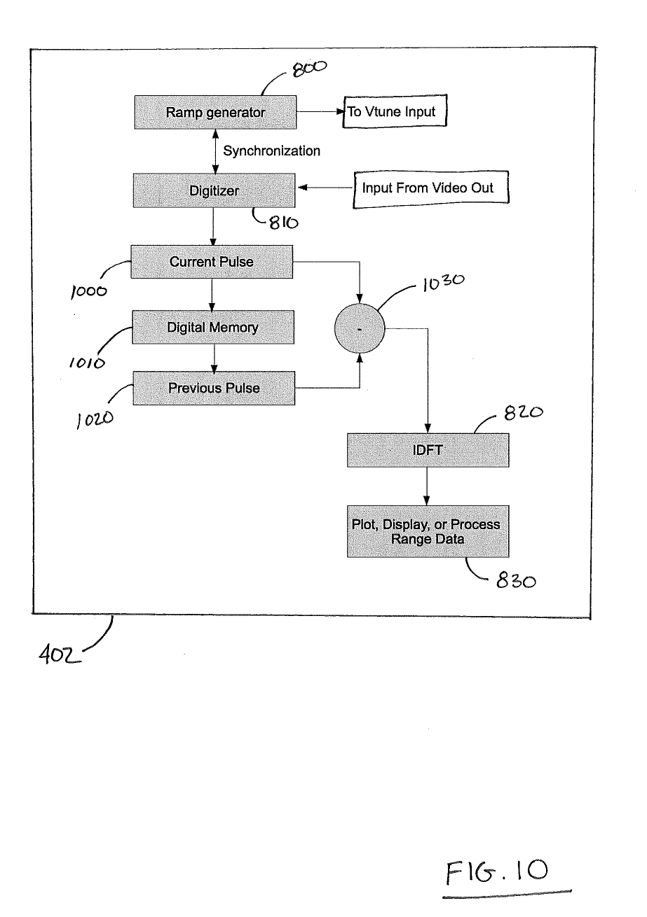

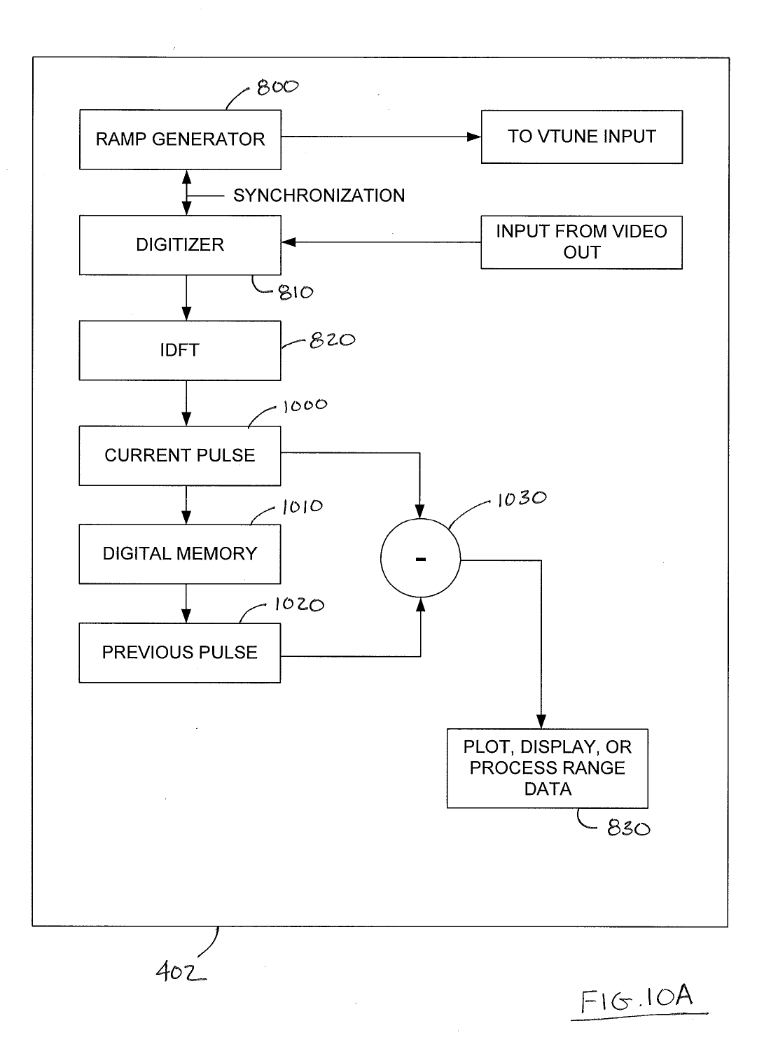

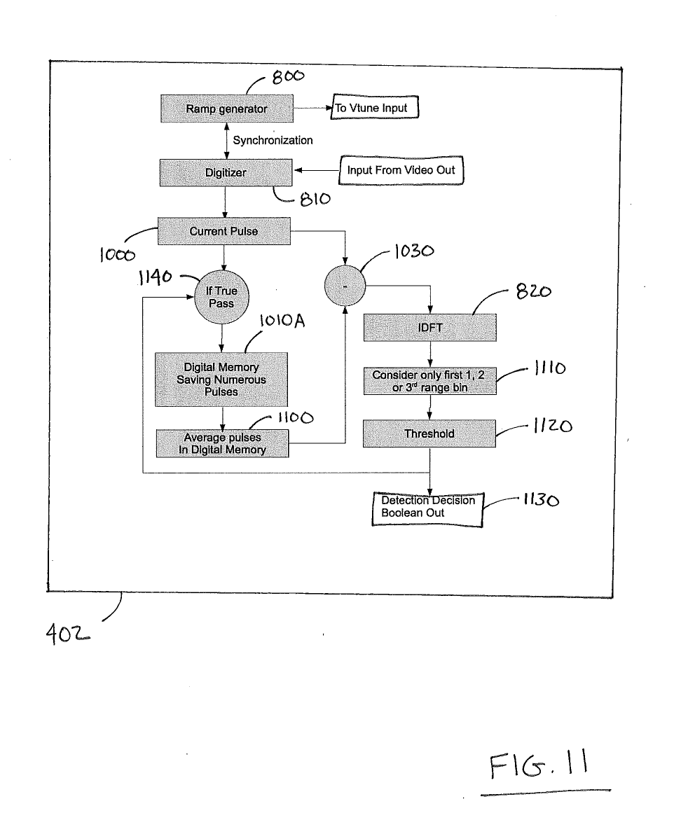

In one aspect referring to, for example, FIG. 10 and also to FIG. 7A, the processor 402 and/or the radar sensor 409 may be configured, as noted above, for adaptive or dynamic coherent change detection. In a manner similar to that described above, the voltage controlled oscillator OSC1 is ramp-modulated by a ramp generator RG (FIG. 10, Block 800). The ramp generator RG may be controlled in any suitable manner such as by processor 402. It is noted that the voltage controlled oscillator OSC1 may have an RF output that is a linear function of its tuning voltage Vtune input. The output of the voltage controlled oscillator OSC1 may be a frequency varying in time according to the modulation. This waveform is amplified by amplifier AMP1, split by a power splitter SPLTR1 and radiated out transmit antenna ANT1 towards a target scene such as a parking space or parking area. As may be realized, it may take time for the transmitted waveform to propagate from the antenna ANT1 to the target (such as a vehicle) and back to a receiver antenna ANT2. This round-trip time may delay the frequency varying waveform in proportion to a target distance and wave propagation velocity. This scattered signal (e.g. the return signal reflected off of the target) is collected by the receiver antenna ANT2, amplified by a low-noise amplifier LNA1, and fed into a frequency multiplier (or mixer) MXR1. Within the mixer MXR1, the original waveform from the splitter SPLTR1 is multiplied by the scattered waveform (which is also delayed in time). After multiplication, the slight frequency difference due to the delayed waveform (e.g. a phase differential) being multiplied by the reference waveform produces a single-frequency or beat tone. This single frequency is proportional to delay and therefore proportional to range. It is noted that the further the target is away from the radar sensor 400 the higher the beat tone will be. If multiple targets are present then multiple beat tones are superimposed on each other, providing a spatial frequency representation of a target scene (see FIGS. 9A and 9B described below). As may be realized, frequency modulated continuous wave data may be in the spatial frequency domain (e.g. the coherent return signal and the output signals define a spatial frequency signal). The output of the mixer MXR1 may be amplified and filtered (low-pass filter for anti-aliasing purposes) by, for example, a video amplifier and fed to a digitizer (FIG. 10, Block 810) through a Video Out port 409P of the sensor 400. Analog data from the Video Out port is digitized in any suitable manner. A finite number of samples may be acquired where the finite number of samples is identical in duration to the time duration of the ramp modulation. Digitizing the analog data produces a “current output signal pulse” or “current pulse” (FIG. 10, Block 1000). In this aspect, where there is no “previous output signal pulse” or “previous pulse” (e.g. a pulse that is serially provided prior to the current pulse) the inverse discrete Fourier transform is applied to the digitized signal for the current pulse (FIG. 10, Block 820). The current pulse is also stored in any suitable memory (FIG. 10, Block 1010), such as memory 403 (FIG. 2), to produce the previous pulse (FIG. 10, Block 1020). When a previous pulse is obtained through receipt of a current pulse, the current pulse is coherently subtracted from the previous pulse (FIG. 10, Block 1030) so that the inverse discrete Fourier Transform is applied (FIG. 10, Block 820) to the difference between the current pulse and the previous pulse. When subtracting the previous pulse from the current pulse only the changes are passed through to the inverse discrete Fourier Transform such that in one aspect when the inverse discrete Fourier Transform is applied (FIG. 10, Block 820) only the targets that changed from the current pulse to the previous pulse are presented (FIG. 10, Block 830). In other aspect, all targets may be presented after application of the inverse discrete Fourier Transform. Here is it noted that the processor 402 of the sensor 400 may be configured to detect vehicle presence from a comparison between sensor characteristics that are defined by differing or different output signal pulses (e.g. at least one current output signal pulse and at least one previous, or earlier, output signal pulse) and to determine changes between the characteristics from the differing or different output signal pulses.

In one aspect, to save memory space in the sensor 400 as can be seen in FIG. 10A, the inverse discrete Fourier Transform may be applied (FIG. 10A, Block 820) to the digitized signal from the digitizer. Here the transformed current and previous pulses (i.e. in both amplitude and phase) are subtracted from one another (FIG. 10A, Block 1030). Passing the digitizer output through the inverse discrete Fourier Transform prior to coherent change detection may allow for the comparison of discrete data portion (e.g. in the domain of the current pulse or in other words in the relevant range bins) rather than a comparison over the whole continuous pulse.

As may be realized, coherent change detection may reduce clutter and the transmit-to-receive coupling for frequency modulated continuous wave radar systems, however coherent change detection (in a conventional approach) may only pass targets that are moving, such as vehicles moving through a parking area or along a navigable roadway. Targets, such as parked vehicles, that are stationary drop in amplitude and may not plotted when using coherent change detection. In one aspect, in addition to detecting moving vehicles in a parking area or on a navigable roadway, parked vehicles may also be detected in a manner similar to that illustrated in FIG. 10 however, in this aspect the current pulse is subtracted from an average or summation of a number of previous pulses. In this aspect the average or summation of background pulses is established in a selective or adaptive manner, where pulses are placed into the average only when there is no target present (as described further below).

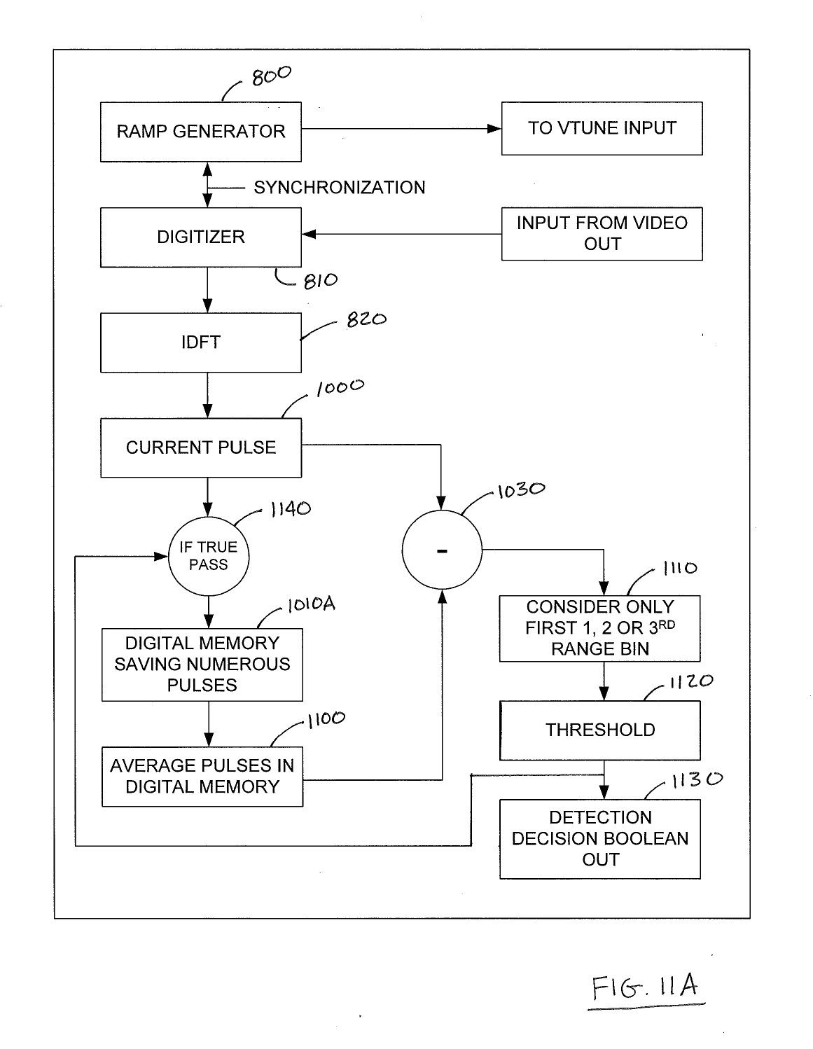

Referring to FIG. 11 and also to FIG. 7A, the processor 402 and/or the radar sensor 409 may be configured, as noted above, so that the output signal of the radar sensor 409 is based on phase coherent signal processing of a spatial frequency signal with both amplitude and phase differentiation and summation over a complex time domain. In a manner similar to that described above, the voltage controlled oscillator OSC1 is ramp-modulated by a ramp generator RG (FIG. 11, Block 800). The ramp generator RG may be controlled in any suitable manner such as by processor 402. It is noted that the voltage controlled oscillator OSC1 may have an RF output that is a linear function of its tuning voltage Vtune input. The output of the voltage controlled oscillator OSC1 may be a frequency varying in time according to the modulation. This waveform is amplified by amplifier AMP1, split by a power splitter SPLTR1 and radiated out transmit antenna ANT1 towards a target scene such as a parking space or parking area. As may be realized, it may take time for the transmitted waveform to propagate from the antenna ANT1 to the target (such as a vehicle) and back to a receiver antenna ANT2. This round-trip time may delay the frequency varying waveform in proportion to a target distance and wave propagation velocity. This scattered signal (e.g. the return signal reflected off of the target) is collected by the receiver antenna ANT2, amplified by a low-noise amplifier LNA1, and fed into a frequency multiplier (or mixer) MXR1. Within the mixer MXR1, the original waveform from the splitter SPLTR1 is multiplied by the scattered waveform (which is also delayed in time). After multiplication, the slight frequency difference due to the delayed waveform (e.g. a phase differential) being multiplied by the reference waveform produces a single-frequency or beat tone. This single frequency is proportional to delay and therefore proportional to range. It is noted that the further the target is away from the radar sensor 400 the higher the beat tone will be. If multiple targets are present then multiple beat tones are superimposed on each other, providing a spatial frequency representation of a target scene (see FIGS. 9A and 9B described herein). As may be realized, frequency modulated continuous wave data may be in the spatial frequency domain (e.g. the coherent return signal and the output signals define a spatial frequency signal). The output of the mixer MXR1 may be amplified and filtered (low-pass filter for anti-aliasing purposes) by a video amplifier and fed to a digitizer (FIG. 11, Block 810) through a Video Out port 409P of the sensor 400. Analog data from the Video Out port is digitized in any suitable manner. A finite number of samples may be acquired where the finite number of samples is identical in duration to the time duration of the ramp modulation. Digitizing the analog data produces a “current output signal pulse” or “current pulse” (FIG. 11, Block 1000). In this aspect, where there is no “previous output signal pulse” or “previous pulse” (e.g. a pulse that is serially provided prior to the current pulse) the inverse discrete Fourier transform is applied to the digitized signal for the current pulse (FIG. 11, Block 820). The current pulse is also stored in any suitable memory (FIG. 11, Block 1010A), such as memory 403 (FIG. 2), to produce an average or summation of the previous pulses (FIG. 11, Block 1100).

As may be realized the radar sensor 409 may operate on any suitable low frequency bandwidth such as at, for example about 180 MHz. Where the radar sensor 409 is operating in a frequency modulated continuous wave radar mode, the first one (corresponding to near 0 range and suitable for detecting obstructions), two or three range bins (corresponding to closer targets, e.g. cars, and further targets, e.g. trucks and other vehicles that are positions higher off the ground), or any other suitable number of range bins, may be examined (e.g. the phase coherent processing is applied to each range bin) to determine if the threshold 1200 has been exceeded (FIG. 11, Blocks 1110 and 1120) for a radar sensor operating at 180 MHz of bandwidth (or any other suitable low frequency bandwidth). A running average of the magnitude of the desired range bin(s) may be computed (FIG. 11, Block 1100) by, for example, the processor 402 or radar sensor 409. A coherent average (with both phase and amplitude) of the range bin is also determined. If as described above the change detection magnitude is greater than the running average of the magnitude by any suitable predetermined threshold 1200 then the coherent average stops averaging and a vehicle detection is logged by the sensor 400 (FIG. 11, Block 1130). On the next pulse, the current pulse may be coherently subtracted (FIG. 11, Block 1030) from the coherent average, but not the previous pulse, when a difference in amplitude is greater than a predetermined threshold for stationary or moving targets such as vehicles within parking spaces or parking areas. The algorithm continues to subtract just from the coherent average, not updating the coherent average, until the difference in amplitude drops below the predetermined threshold. When the difference in amplitude stays below the predetermined threshold the coherent average is updated (FIG. 11, Block 1140). Here the radar sensor 409 may include suitable hardware and/or software for effecting the dynamic coherent change detection but in other aspects the radar sensor 409 may communicate with the processor 402 which may effect the dynamic coherent change detection as described herein.

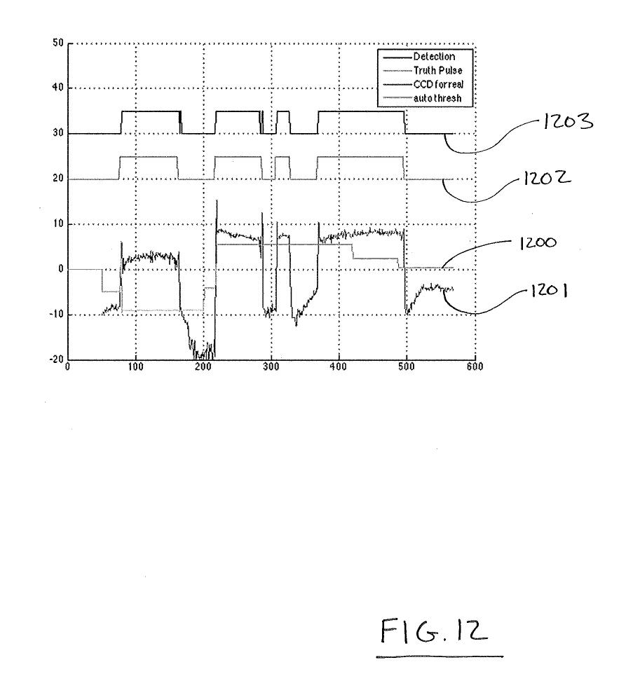

Referring also to FIG. 12, an exemplary output plot from e.g. the phase coherent processing is illustrated to show the phase coherent processing algorithm effectively detecting the presence of parked vehicles. Here the sum of, for example, range bins 2 and 3 are plotted just before the input to the threshold 1201. The dynamic threshold 1200 and the threshold output Boolean 1203 (i.e. true or false) are also plotted. In FIG. 12, a ground truth signal 1202 is also shown, e.g. for demonstration purposes only (manually logged by a technician testing the vehicle detection system) showing the efficacy of the system. As may be realized when a vehicle moves into a parking space it will trigger a large radar response on the coherent change detection output which begins this selective or adaptive process. These previous pulses are selected for averaging only if they do not exceed a predetermined coherent change detection threshold 1200. As may be realized the threshold is set or predetermined over the adaptive/dynamic (averaged) baseline as previously described. If a given pulse exceeds a threshold then the Boolean output 1203 of the algorithm goes high and this pulse is not saved into the rolling average. If a threshold 1200 is not crossed then the pulse goes into the rolling average and the Boolean output 1203 remains low.

In one aspect, to save memory space in the sensor 400 as can be seen in FIG. 11A, the inverse discrete Fourier Transform may be applied (FIG. 11A, Block 820) to the digitized signal from the digitizer. Here the transformed current and averaged previous pulses are subtracted from one another (FIG. 11A, Block 1030). As noted above, passing the digitizer output through the inverse discrete Fourier Transform prior to coherent change detection may allow for the comparison of discrete data portion (e.g. in the relevant range bins) rather than a comparison over the whole pulse.

In other aspects, vehicle detection may occur in a manner similar to that described above however, an amplitude-only detection algorithm using frequency modulated continuous waver radar may be used, where only amplitude changes in data, due to, for example, inverse discrete Fourier Transform are used to trigger detection. In another aspect, vehicle detection may occur in a manner similar to that described above however, a phase-only detection algorithm using frequency modulated continuous waver radar may be used, where only amplitude changes in data, due to, for example, inverse discrete Fourier Transform are used to trigger detection. In yet another aspect, vehicle detection may occur in a manner similar to that described above however, a phase and amplitude-only detection algorithm using frequency modulated continuous waver radar may be used, where only amplitude changes in data, due to, for example, inverse discrete Fourier Transform are used to trigger detection.

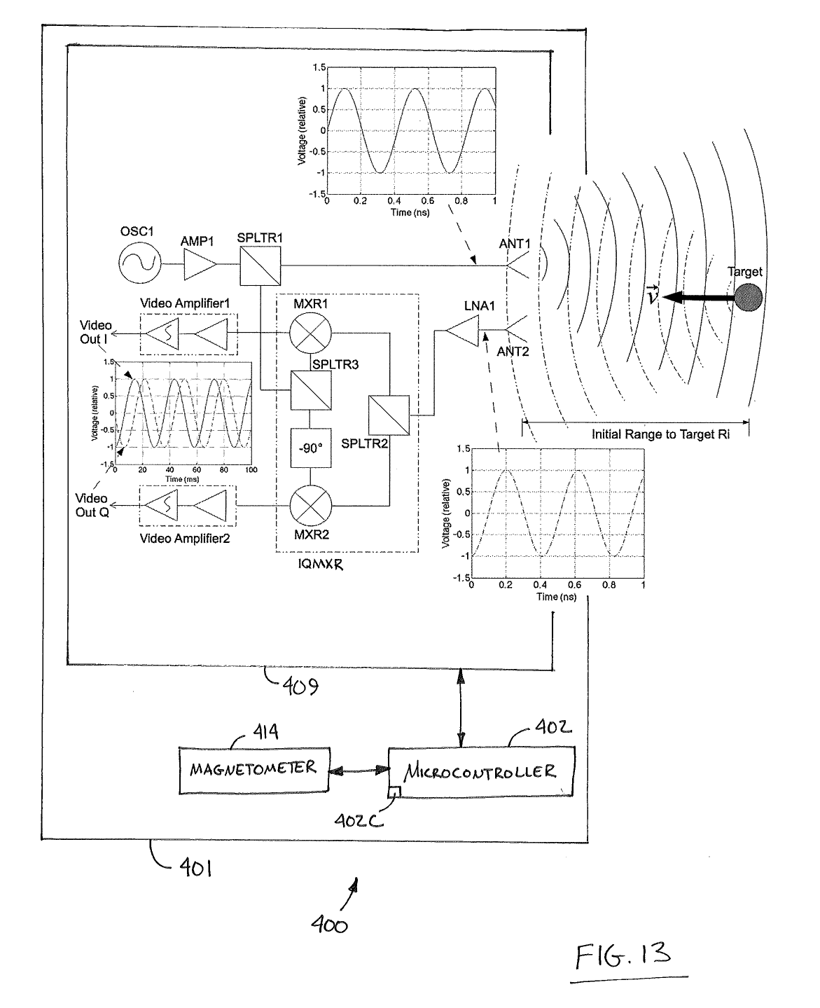

Referring to FIG. 13, vehicle detection may occur in a manner similar to that described above however, in this aspect an IQ quadrature mixer IQMXR may be used in place of mixer MXR1 (see FIG. 7A), where both real and imaginary scattered waveforms are sampled. This may improve the effectiveness of the processing described above, or facilitate ease of amplitude, phase or amplitude and phase detection. Here the IQ quadrature mixer IQMXR may include splitter SPLTR2 that provides a return waveform signal to mixers MXR1, MXR2. A splitter SPLTR3 receives signals from splitter SPLTR1 and provides signals to mixers MXR1, MXR2. The signal to mixer MXR2 (or MXR1) may be sifted by any suitable amount, such as 90° relative to the signal provided to the other mixer MXR1 (or MXR2). A pair of video amplifiers may provide a plot or display of the signals in any suitable manner.

In one aspect Doppler techniques (such as those described above) may also be employed in the processing describe above where the phase of an incoming vehicle is tracked knowing that the vehicle is approaching the radar sensor. Here the outgoing phase would trigger a departure. Knowing arrivals and departures would provide whether a target is present. It is noted that Doppler radar architecture is similar to frequency modulated continuous waver radar such that an IQ mixer similar to that illustrated in FIG. 13 may be employed. Additionally, the oscillator may be connected directly to the transmit antenna and an envelope detector connected to the receive antenna so that an amplitude only radar sensor is implemented.

In accordance with one or more aspects of the disclosed embodiment a vehicle detection sensor apparatus is provided. The vehicle detection sensor apparatus includes a frame and a dual mode sensor connected to the frame. The dual mode sensor having an active and a passive sensing mode wherein at least one of the active and passive sensing mode is automatically cycled between on and off states when providing a positive reading condition.

In accordance with one or more aspects of the disclosed embodiment a positive reading condition is provided in the active and passive sensing mode when a vehicle is being detected in the active and passive sensing mode.

In accordance with one or more aspects of the disclosed embodiment the active sensing mode is effected by a directed beam sensor and the passive sensing mode is effected by a magnetic sensor.

In accordance with one or more aspects of the disclosed embodiment the vehicle detection sensor apparatus includes an onboard timer configured to wake up at least one of the directed beam sensor and the magnetic sensor.

In accordance with one or more aspects of the disclosed embodiment the onboard timer is configured to wake up the directed beam sensor and the magnetic sensor in a predetermined sequence.

In accordance with one or more aspects of the disclosed embodiment a vehicle detection sensor apparatus is provided. The vehicle detection sensor apparatus includes a frame and a dual mode sensor connected to the frame. The dual mode sensor having an active and a passive sensing mode wherein at least one of the active and passive sensing mode is cycled between on and off states to provide sampling readings of a positive reading condition.

In accordance with one or more aspects of the disclosed embodiment the at least one of the active and passive sensing mode is cycled between on and off states to provide sampling readings of a transition between the positive reading condition and a null reading condition.

In accordance with one or more aspects of the disclosed embodiment the positive reading condition is provided in the active and passive sensing mode when a vehicle is being detected in the active and passive sensing modes.

In accordance with one or more aspects of the disclosed embodiment the null reading condition is provided when there is no vehicle detected in the active and passive sensing modes.

In accordance with one or more aspects of the disclosed embodiment the active sensing mode is effected by a directed beam sensor and the passive sensing mode is effected by a magnetic sensor.

In accordance with one or more aspects of the disclosed embodiment the vehicle detection sensor apparatus includes an onboard timer configured to wake up at least one of the directed beam sensor and the magnetic sensor.

In accordance with one or more aspects of the disclosed embodiment the onboard timer is configured to wake up the directed beam sensor and the magnetic sensor in a predetermined sequence.

In accordance with one or more aspects of the disclosed embodiment a vehicle detection sensor apparatus is provided. The vehicle detection sensor apparatus includes a frame and a dual mode sensor connected to the frame wherein the dual mode sensor is embedded in a vehicle driving surface and provides omnidirectional vehicle detection within a predetermined zone of sensation.

In accordance with one or more aspects of the disclosed embodiment the dual mode sensor includes an omnidirectional magnetic sensor and a directed beam sensor.

In accordance with one or more aspects of the disclosed embodiment the omnidirectional magnetic sensor is a three dimensional magnetometer.

In accordance with one or more aspects of the disclosed embodiment the omnidirectional magnetic sensor is a primary sensor and the directed beam sensor is a secondary sensor configured to validate readings of the primary sensor.

In accordance with one or more aspects of the disclosed embodiment the frame comprises a housing configured to allow the embedding of the vehicle detection sensor apparatus within the ground.

In accordance with one or more aspects of the disclosed embodiment a vehicle detection sensor apparatus is provided. The vehicle detection sensor apparatus includes a frame, at least one vehicle detection sensor connected to the frame, at least one communication module connected to the frame and dual timers connected to the at least one vehicle detection sensor and the at least one communication module. A first one of the dual timers being configured to cycle the at least one vehicle detection sensor between on and off states and a second one of the dual timers being configured to effect cycling of vehicle detection sensor apparatus communication.

In accordance with one or more aspects of the disclosed embodiment each of the timers has a timing resolution different from the other one of the timers.

In accordance with one or more aspects of the disclosed embodiment the first one of the dual timers is configured to cycle the at least one sensor when the at least one sensor is providing a positive reading condition.

In accordance with one or more aspects of the disclosed embodiment a positive reading condition is provided when a vehicle is being detected by the at least one sensor.

In accordance with one or more aspects of the disclosed embodiment the first one of the dual timers is configured to cycle the at least one sensor when the at least one sensor is providing readings of a transition between the positive reading condition and a null reading condition.

In accordance with one or more aspects of the disclosed embodiment the null reading condition is provided when there is no vehicle detected in the active and passive sensing modes.

In accordance with one or more aspects of the disclosed embodiment wherein the second one of the dual timers is configured to cycle the vehicle detection sensor apparatus communication between on and off states so that communication is on at a sensor transition event.

In accordance with one or more aspects of the disclosed embodiment the sensor transition event comprises a change in state of a sensor reading.

In accordance with one or more aspects of the disclosed embodiment a method in a vehicle detection system is provided. The method includes cycling at least one vehicle detection sensor between on and off states with a first timer of a dual mode timer and cycling of vehicle detection sensor apparatus communication with a second timer of the dual mode timer.

In accordance with one or more aspects of the disclosed embodiment each of the timers has a timing resolution different from the other one of the timers.

In accordance with one or more aspects of the disclosed embodiment the method includes cycling the at least one sensor with the first timer when the at least one sensor is providing a positive reading condition.

In accordance with one or more aspects of the disclosed embodiment a positive reading condition is provided when a vehicle is being detected by the at least one sensor.

In accordance with one or more aspects of the disclosed embodiment the method includes cycling the at least one sensor with the first timer when the at least one sensor is providing readings of a transition between the positive reading condition and a null reading condition.

In accordance with one or more aspects of the disclosed embodiment the null reading condition is provided when there is no vehicle detected in the active and passive sensing modes.

In accordance with one or more aspects of the disclosed embodiment the method includes cycling the vehicle detection sensor apparatus communication between on and off states with the second timer so that communication is on at a sensor transition event.

In accordance with one or more aspects of the disclosed embodiment the sensor transition event comprises a change in state of a sensor reading.

In accordance with one or more aspects of the disclosed embodiment wherein the at least one sensor includes a primary sensor and secondary sensor and the method includes providing a primary vehicle detection sensor with a baseline setting and a threshold setting, providing an indication of a state change of the primary vehicle detection sensor and confirming the state change with a secondary vehicle detection sensor.

In accordance with one or more aspects of the disclosed embodiment the baseline setting is provided as a null sensor reading when the primary vehicle detection sensor detects an absence of a vehicle and the threshold setting is provided as a positive reading when the primary vehicle detection sensor detects a presence of a vehicle.

In accordance with one or more aspects of the disclosed embodiment wherein at least the threshold setting includes an upper limit and lower limit and the method includes using the secondary vehicle detection sensor to confirm the null sensor reading and recalibrating the primary vehicle detection sensor to baseline settings.

In accordance with one or more aspects of the disclosed embodiment wherein at least the baseline setting includes an upper limit and lower limit and the method includes using the secondary vehicle detection sensor to confirm the null sensor reading and recalibrating the primary vehicle detection sensor to baseline settings.

In accordance with one or more aspects of the disclosed embodiment the method includes initiating recalibration of the primary vehicle detection sensor with a central controller of a vehicle detection system.

In accordance with one or more aspects of the disclosed embodiment wherein the primary and secondary vehicle detection sensor are housed in a vehicle detection unit and the method includes initiating recalibration of the primary vehicle detection sensor with the vehicle detection unit.

In accordance with one or more aspects of the disclosed embodiment the method includes registering data corresponding to the state changes of the primary vehicle detection sensor.

In accordance with one or more aspects of the disclosed embodiment a vehicle detection sensor apparatus is provided. The vehicle detection sensor apparatus includes a housing, at least one sensor and a processor connected to the at least one sensor, the at least one sensor and processor being disposed within the housing. The housing being configured for embedment in a navigable roadway and the at least one sensor is configured for remote sensing of vehicles passing over the vehicle detection sensor apparatus. The processor is configured to receive information from the at least one sensor and count a number of vehicles passing over the vehicle detection sensor apparatus.

In accordance with one or more aspects of the disclosed embodiment the at least one sensor includes a radar sensor and the processor is configured to count the number of vehicles based on a Doppler effect of the radar sensor.

In accordance with one or more aspects of the disclosed embodiment a vehicle detection sensor apparatus includes a frame; and at least one pulse compression micro radar sensor with moving target resolution corresponding to each vehicle parking space within an array of vehicle parking spaces so that each different vehicle parking space has a different corresponding pulse compression micro radar sensor of the at least one pulse compression micro radar sensor.

In accordance with one or more aspects of the disclosed embodiment the at least one pulse compression micro radar sensor is a low frequency radar sensor.

In accordance with one or more aspects of the disclosed embodiment output signal processing of the at least one pulse compression micro radar sensor has both phase and amplitude differentiation in both a frequency domain and a time domain.

In accordance with one or more aspects of the disclosed embodiment the time domain is of a common signal pulse.

In accordance with one or more aspects of the disclosed embodiment the time domain spans different signal pulses.

In accordance with one or more aspects of the disclosed embodiment the at least one pulse compression micro radar sensor is one of a continuous wave radar sensor, a frequency modulated continuous wave radar sensor and an impulse radar sensor with phase coherent processing.

In accordance with one or more aspects of the disclosed embodiment each pulse compression micro radar sensor corresponds to at least one parking space.

In accordance with one or more aspects of the disclosed embodiment the at least one pulse compression micro radar sensor corresponds to at least one parking space.

In accordance with one or more aspects of the disclosed embodiment the frame comprises a protective housing configured to be at least partially embedded within a vehicle travel surface.

In accordance with one or more aspects of the disclosed embodiment a vehicle detection sensor apparatus includes a frame; and a dual mode sensor connected to the frame, the dual mode sensor having at least one low frequency micro radar sensor with moving target processing effecting high frequency radar sensitivity.

In accordance with one or more aspects of the disclosed embodiment the frame comprises a protective housing configured to be at least partially embedded within a vehicle travel surface.

In accordance with one or more aspects of the disclosed embodiment the vehicle detection sensor apparatus further includes a processor configured to effect phase coherent processing of return waveforms.

In accordance with one or more aspects of the disclosed embodiment the phase coherent processing includes both phase and amplitude differentiation and summation over a complex time domain.

In accordance with one or more aspects of the disclosed embodiment the complex time domain is of a common signal pulse.

In accordance with one or more aspects of the disclosed embodiment the complex time domain spans different signal pulses.

In accordance with one or more aspects of the disclosed embodiment the at least one low frequency micro radar sensor is one of a continuous wave radar sensor, a frequency modulated continuous wave radar sensor and an impulse radar sensor with phase coherent processing.

In accordance with one or more aspects of the disclosed embodiment each low frequency micro radar sensor corresponds to at least one parking space in an array of parking spaces.

In accordance with one or more aspects of the disclosed embodiment the at least one low frequency micro radar sensor corresponds to at least one parking space of an array of vehicle parking spaces so that each different vehicle parking space has a different corresponding low frequency micro radar sensor of the at least one low frequency micro radar sensor.

In accordance with one or more aspects of the disclosed embodiment the dual mode sensor includes at least one magnetic vehicle detection sensor.

In accordance with one or more aspects of the disclosed embodiment the frame comprises a protective housing configured for mounting above a vehicle travel surface.

In accordance with one or more aspects of the disclosed embodiment a vehicle detection sensor apparatus includes a frame; and at least one directed beam sensor configured so that an output signal of the directed beam sensor is based on phase coherent signal processing of a spatial frequency signal with both amplitude and phase differentiation and summation.

In accordance with one or more aspects of the disclosed embodiment the at least one directed beam sensor is a pulse compression micro radar sensor.

In accordance with one or more aspects of the disclosed embodiment the amplitude and phase differentiation is in both a frequency domain and a time domain.

In accordance with one or more aspects of the disclosed embodiment the time domain is of a common signal pulse.

In accordance with one or more aspects of the disclosed embodiment the time domain spans different signal pulses.

In accordance with one or more aspects of the disclosed embodiment the at least one directed beam sensor is one of a continuous wave radar sensor, a frequency modulated continuous wave radar sensor and an impulse radar sensor.

In accordance with one or more aspects of the disclosed embodiment the at least one directed beam sensor is a low frequency radar sensor.

In accordance with one or more aspects of the disclosed embodiment each directed beam sensor corresponds to at least one parking space in an array of parking spaces.

In accordance with one or more aspects of the disclosed embodiment the at least one directed beam sensor corresponds to at least one parking space of an array of vehicle parking spaces so that each different vehicle parking space has a different corresponding directed beam sensor of the at least one directed beam sensor.

In accordance with one or more aspects of the disclosed embodiment the frame comprises a protective housing configured to be at least partially embedded within a vehicle travel surface.

In accordance with one or more aspects of the disclosed embodiment a method in a vehicle detection system is provided. The method includes providing a vehicle detection sensor with a low frequency micro radar and a processor; and providing, with the processor, a processing of radar pulses to effect moving target resolution; wherein the processing includes differentiating a coherent output signal of different signal pulses with both amplitude and phase differentiation, and maintaining a rolling threshold average of the coherent output signal of the different signal pulses with both amplitude and phase summation over a complex time domain.

In accordance with one or more aspects of the disclosed embodiment the complex time domain is of a common signal pulse.

In accordance with one or more aspects of the disclosed embodiment the complex time domain spans different signal pulses.

In accordance with one or more aspects of the disclosed embodiment the micro radar is one of a continuous wave radar sensor, a frequency modulated continuous wave radar sensor and an impulse radar sensor with phase coherent processing.

In accordance with one or more aspects of the disclosed embodiment the micro radar is a low frequency radar sensor.

It should be understood that the foregoing description is only illustrative of the aspects of the disclosed embodiment. Various alternatives and modifications can be devised by those skilled in the art without departing from the aspects of the disclosed embodiment. Accordingly, the aspects of the disclosed embodiment are intended to embrace all such alternatives, modifications and variances that fall within the scope of the appended claims. Further, the mere fact that different features are recited in mutually different dependent or independent claims does not indicate that a combination of these features cannot be advantageously used, such a combination remaining within the scope of the aspects of the invention.

What is claimed is:

1. A vehicle detection sensor apparatus comprising:
a frame; and
a dual mode sensor connected to the frame, the dual mode sensor having an active and a passive sensing mode wherein at least one of the active and passive sensing mode is automatically cycled between on and off states when providing a positive reading condition.

2. The vehicle detection sensor apparatus of claim 1, wherein a positive reading condition is provided in the active and passive sensing mode when a vehicle is being detected in the active and passive sensing mode.

3. The vehicle detection sensor apparatus of claim 1, wherein the active sensing mode is effected by a directed beam sensor and the passive sensing mode is effected by a magnetic sensor.

4. The vehicle detection sensor apparatus of claim 1, further comprising an onboard timer configured to wake up at least one of the directed beam sensor and the magnetic sensor.

5. The vehicle detection sensor apparatus of claim 4, wherein the onboard timer is configured to wake up the directed beam sensor and the magnetic sensor in a predetermined sequence.

6. A vehicle detection sensor apparatus comprising:
a frame; and
a dual mode sensor connected to the frame, the dual mode sensor having an active and a passive sensing mode wherein at least one of the active and passive sensing mode is cycled between on and off states to provide sampling readings of a positive reading condition.

7. The vehicle detection sensor apparatus of claim 6, wherein the at least one of the active and passive sensing mode is cycled between on and off states to provide sampling readings of a transition between the positive reading condition and a null reading condition.

8. The vehicle detection sensor apparatus of claim 7, wherein the positive reading condition is provided in the active and passive sensing mode when a vehicle is being detected in the active and passive sensing modes.

9. The vehicle detection sensor apparatus of claim 7, wherein the null reading condition is provided when there is no vehicle detected in the active and passive sensing modes.

10. The vehicle detection sensor apparatus of claim 6, wherein the active sensing mode is effected by a directed beam sensor and the passive sensing mode is effected by a magnetic sensor.

11. The vehicle detection sensor apparatus of claim 6, further comprising an onboard timer configured to wake up at least one of the directed beam sensor and the magnetic sensor.

12. The vehicle detection sensor apparatus of claim 11, wherein the onboard timer is configured to wake up the directed beam sensor and the magnetic sensor in a predetermined sequence.

13. A vehicle detection sensor apparatus comprising:
a frame; and
a dual mode sensor connected to the frame wherein the dual mode sensor is embedded in a vehicle driving surface and provides omnidirectional vehicle detection within a predetermined zone of sensation.

14. The vehicle detection sensor apparatus of claim 13, wherein the dual mode sensor includes an omnidirectional magnetic sensor and a directed beam sensor.

15. The vehicle detection sensor apparatus of claim 14, wherein the omnidirectional magnetic sensor is a three dimensional magnetometer.

16. The vehicle detection sensor apparatus of claim 14, wherein the omnidirectional magnetic sensor is a primary sensor and the directed beam sensor is a secondary sensor configured to validate readings of the primary sensor.

17. The vehicle detection sensor apparatus of claim 13, wherein the frame comprises a housing configured to allow the embedding of the vehicle detection sensor apparatus within the ground.

18. A vehicle detection sensor apparatus comprising:
a frame,
at least one vehicle detection sensor connected to the frame,
at least one communication module connected to the frame; and
dual timers connected to the at least one vehicle detection sensor and the at least one communication module, a first one of the dual timers being configured to cycle the at least one vehicle detection sensor between on and off states and a second one of the dual timers being configured to effect cycling of vehicle detection sensor apparatus communication.

19. The vehicle detection sensor apparatus of claim 18, wherein each of the timers has a timing resolution different from the other one of the timers.

20. The vehicle detection sensor apparatus of claim 18, wherein the first one of the dual timers is configured to cycle the at least one sensor when the at least one sensor is providing a positive reading condition.

21. The vehicle detection sensor apparatus of claim 20, wherein a positive reading condition is provided when a vehicle is being detected by the at least one sensor.

22. The vehicle detection sensor apparatus of claim 18, the first one of the dual timers is configured to cycle the at least one sensor when the at least one sensor is providing readings of a transition between the positive reading condition and a null reading condition.

23. The vehicle detection sensor apparatus of claim 22, the null reading condition is provided when there is no vehicle detected in the active and passive sensing modes.

24. The vehicle detection sensor apparatus of claim 18, wherein the second one of the dual timers is configured to cycle the vehicle detection sensor apparatus communication between on and off states so that communication is on at a sensor transition event.

25. The vehicle detection sensor apparatus of claim 24, the sensor transition event comprises a change in state of a sensor reading.

26. A method in a vehicle detection system, the method comprising:
cycling at least one vehicle detection sensor between on and off states with a first timer of a dual mode timer; and
cycling of vehicle detection sensor apparatus communication with a second timer of the dual mode timer.

27. The method of claim 26, wherein each of the timers has a timing resolution different from the other one of the timers.

28. The method of claim 26, further comprising cycling the at least one sensor with the first timer when the at least one sensor is providing a positive reading condition.

29. The method of claim 28, wherein a positive reading condition is provided when a vehicle is being detected by the at least one sensor.

30. The method of claim 26, further comprising cycling the at least one sensor with the first timer when the at least one sensor is providing readings of a transition between the positive reading condition and a null reading condition.

31. The method of claim 30, wherein the null reading condition is provided when there is no vehicle detected in the active and passive sensing modes.

32. The method of claim 26, further comprising cycling the vehicle detection sensor apparatus communication between on and off states with the second timer so that communication is on at a sensor transition event.

33. The method of claim 32, wherein the sensor transition event comprises a change in state of a sensor reading.

34. The method of claim 26, wherein the at least one sensor includes a primary sensor and secondary sensor and the method further comprises:
providing a primary vehicle detection sensor with a baseline setting and a threshold setting;
providing an indication of a state change of the primary vehicle detection sensor; and
confirming the state change with a secondary vehicle detection sensor.

35. The method of claim 34, wherein the baseline setting is provided as a null sensor reading when the primary vehicle detection sensor detects an absence of a vehicle and the threshold setting is provided as a positive reading when the primary vehicle detection sensor detects a presence of a vehicle.

36. The method of claim 35, wherein at least the threshold setting includes an upper limit and lower limit and the method includes using the secondary vehicle detection sensor to confirm the null sensor reading and recalibrating the primary vehicle detection sensor to baseline settings.

37. The method of claim 34, wherein at least the baseline setting includes an upper limit and lower limit and the method includes using the secondary vehicle detection sensor to confirm the null sensor reading and recalibrating the primary vehicle detection sensor to baseline settings.

38. The method of claim 34, further comprising initiating recalibration of the primary vehicle detection sensor with a central controller of a vehicle detection system.

39. The method of claim 34, wherein the primary and secondary vehicle detection sensor are housed in a vehicle detection unit and the method includes initiating recalibration of the primary vehicle detection sensor with the vehicle detection unit.

40. The method of claim 34, further comprising registering data corresponding to the state changes of the primary vehicle detection sensor.

41. A vehicle detection sensor apparatus comprising:
a housing;
at least one sensor; and
a processor connected to the at least one sensor, the at least one sensor and processor being disposed within the housing, the housing being configured for embedment in a navigable roadway and the at least one sensor is configured for remote sensing of vehicles passing over the vehicle detection sensor apparatus;
wherein the processor is configured to receive information from the at least one sensor and count a number of vehicles passing over the vehicle detection sensor apparatus.

42. The vehicle detection sensor apparatus of claim 41, wherein the at least one sensor includes a radar sensor and the processor is configured to count the number of vehicles based on a Doppler effect of the radar sensor.

43. A vehicle detection sensor apparatus comprising:
a frame; and
at least one pulse compression micro radar sensor with moving target resolution corresponding to each vehicle parking space within an array of vehicle parking spaces so that each different vehicle parking space has a different corresponding pulse compression micro radar sensor of the at least one pulse compression micro radar sensor.
